(19) United States
(12) Patent Application Publication
(10) Pub. No.: US 2026/0101193 A1
(43) Pub. Date: Apr. 9, 2026

(54) SYSTEM AND METHODS FOR LATENT APPLET ACTIVATION

(71) Applicant: Capital One Services, LLC, McLean, VA (US)

(72) Inventors: Kevin Osborn, McLean, VA (US); Bob Uni Koshy, Henrico, VA (US); Brian Dotson, McLean, VA (US); Tomasz Ondrusz, McLean, VA (US)

(73) Assignee: Capital One Services, LLC, McLean, VA (US)

(21) Appl. No.: 19/352,311

(22) Filed: Oct. 7, 2025

Related U.S. Application Data
(60) Provisional application No. 63/704,492, filed on Oct. 7, 2024.

(51) Int. Cl. H04W 12/30; H04L 9/32; H04W 12/037; H04W 12/06

(52) U.S. Cl. CPC H04W 12/35; H04L 9/3242; H04W 12/037; H04W 12/06; H04L 2209/80

(57) ABSTRACT

A computer-implemented method and system enable secure activation of applets on contactless cards.

### CROSS-REFERENCE TO RELATED APPLICATIONS

This application claims priority to U.S. Provisional Application 63/704,492, filed Oct. 7, 2024, the disclosure of which is incorporated herein by reference in its entirety.

### BACKGROUND

Prepaid cards, such as prepaid gift cards, have become ubiquitous in completing transactions over the Internet and/or in stores. However, prepaid cards are susceptible to a form of fraud known as “draining” whereby fraudulent actors gather the information from inactivated cards, and wait for the inactivated cards to be activated by real customers, so the criminals can rapidly spend the value using the previously collected information.

These and other deficiencies exist. As such, there is a need for additional security beyond what is already provided on current systems of prepaid cards. For example, prepaid cards need to be enhanced with data security. Systems and processes for the implementation and use of prepaid cards need improving data security.

Further, secure applet activation on any type of contactless card requires safely enabling small applications (applets), often stored on secure elements such as SIM cards or embedded chips. These applets perform sensitive tasks, including payment processing, authentication, or cryptographic operations, and their activation must be strictly controlled to prevent unauthorized access or tampering. However, applet and card activation must be seamless and easy for users to perform. To ensure optimal user experience, both applet installation and card activation processes should be intuitively designed, minimizing steps required and reducing the potential for errors or confusion.

### SUMMARY

Aspects of the present application include prepaid cards, systems and methods of controlling fraud on the prepaid cards.

In one aspect, a prepaid card is provided to have enhanced data security. The prepaid card can have an applet preloaded on the card. The applet can be active or inactive. The prepaid card is required to be activated and registered when a first transaction occurs on the card. The prepaid card can also be activated and registered prior to a first transaction occurring on the card. The activation of the card can launch a website on which the registration process of the card is completed.

In one aspect, a system for controlling fraud on a prepaid card is provided. The system can include the card issuer's device, a mobile phone of a user of the card, a merchant device, and so forth. The mobile phone device is configured to activate and register the card. The card issuer's device is configured to verify the card and/or the user. The merchant device is configured to accept the card for transactions and transmits transaction authentication request to the processing network.

In one aspect, a method of controlling fraud on a prepaid card is provided. The method can include providing a prepaid card having an applet; loading funds onto the card; activating the card; registering the card; verifying the user when the user conducts transactions on the card; and approving or denying the transactions.

In one aspect, a system and computer-implemented method for activating an applet includes several steps. First, a mobile application selects the applet using a shadow application identifier (AID), and in its initial inactive state the applet is set up to respond only to this shadow AID. The mobile application then reads one or more applet-specific identifiers from the applet. These identifiers are sent by the mobile application to a remote service. The remote service generates a cryptographic authenticator at least partly based on the applet-specific identifiers, and this authenticator is received by the mobile application. Next, the mobile application sends a write command to the applet, this command containing the cryptographic authenticator and one or more control bits. Upon successful validation of the cryptographic authenticator, the applet transitions from the initial inactive state to a subsequent active state, at which point it is enabled to respond to the standard NDEF AID and is disabled from responding to the proprietary AID.

In one aspect, a system and method for activating an applet includes the following operations: A mobile application performs a first read operation on the applet and receives a first message from the applet. This message contains one or more identifiers and a cryptogram field that is populated with a predetermined fixed value indicating an inactive state. The mobile application detects the predetermined fixed value in the cryptogram field and then sends the one or more identifiers from the mobile device to a remote service. The mobile application receives a cryptographic authenticator from the remote service. The mobile application then performs a write operation to transmit the cryptographic authenticator to the applet, resulting in the applet validating the cryptographic authenticator and transitioning from an inactive state to an active state.

In another aspect, a contactless card includes a processor and a memory that stores a secure applet. When in its initial inactive state, the secure applet does not respond to selection requests that contain a standard NFC Data Exchange Format (NDEF) Application Identifier (AID). Instead, it responds exclusively to selection requests containing a secret, non-standard Shadow AID that is known only to a trusted activation application. The secure applet is designed to transition from this inactive state to a subsequent active state only if a cryptographic authenticator received from an application is validated successfully. Upon making this transition, the secure applet becomes responsive to the standard NDEF AID, and becomes permanently disabled from responding to the proprietary Shadow AID.

In one aspect, a contactless card includes a processor and a memory that stores an applet and instructions. When executed by the processor, these instructions configure the card such that, upon a first read operation from a mobile device, the card transmits a first message that contains one or more identifiers and a cryptogram field filled with a predetermined fixed value, signaling an initial inactive state of the applet. The card can receive a write operation from the mobile device, where this operation includes a cryptographic authenticator. This authenticator is generated by a remote service based on the aforementioned identifiers. The card validates the cryptographic authenticator, and if validation is successful, transitions the applet from its initial inactive state to an active state. In the active state, a second read operation performed on the applet results in the return of a second message, which contains a dynamically computed cryptogram.

Non-transitory computer program products (e.g., physically embodied computer program products) are also described that store instructions, which, when executed by one or more data processors (e.g., processor circuit) of one or more computing systems, cause at least one data processor to perform one or more of the operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 is a diagram of an example system in accordance with embodiments discussed herein.

FIG. 2 is a block diagram of an example mobile device in accordance with embodiments discussed herein.

FIG. 3 is a block diagram of an example web server in accordance with embodiments discussed herein.

FIG. 4 is a flow chart illustrating a method in accordance with embodiments discussed herein.

FIG. 5 is a flow chart illustrating a method in accordance with embodiments discussed herein.

FIG. 6 is a flow chart illustrating a method in accordance with embodiments discussed herein.

FIG. 7 illustrates an aspect of the subject matter in accordance with one embodiment.

FIG. 8 illustrates a routine 800 for activating an applet residing on a secure element, the applet having an initial inactive state and a subsequent active state in accordance with one embodiment.

FIG. 9 illustrates a routine 900 for activating a secure applet in accordance with one embodiment.

FIG. 10 illustrates a contactless card in accordance with embodiments discussed herein.

FIG. 11 illustrates a contactless card component in accordance with embodiments discussed herein.

FIG. 12 illustrates a sequence flow in accordance with embodiments discussed herein.

FIG. 13 illustrates an example of a system in accordance with embodiments discussed herein.

FIG. 14 illustrates another sequence flow in accordance with embodiments discussed herein.

FIG. 15A illustrates another sequence flow in accordance with embodiments discussed herein.

FIG. 15B illustrates another sequence flow in accordance with embodiments discussed herein.

FIG. 15C illustrates another sequence flow in accordance with embodiments discussed herein.

FIG. 16 illustrates an example message format in accordance with embodiments discussed herein.

FIG. 17 is a block diagram of example computer architecture in accordance with embodiments discussed herein.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

To address the above-mentioned deficiencies, the present disclosure uses techniques described herein to prevent fraud and to aid registering prepaid cards in the registration, as well as validating the actual prepaid card possession, as opposed to, e.g., utilizing the permanent account number (PAN) and card verification value (CVV) to validate transactions.

As used herein, “prepaid cards” refers broadly to any card-based instrument that stores a preloaded monetary value and can be used for transactions until the balance is depleted. Examples of prepaid cards include gift cards, shopping cards, voucher cards, credit cards, and debit cards. Gift cards are typically issued by retailers or financial institutions and may be used for purchases within specified stores or networks. Shopping cards are similar, usually intended for use at specific merchants or a group of affiliated merchants. Voucher cards represent prepaid value for redemption of specific goods or services and may function as electronic vouchers rather than general-purpose payment methods. In some contexts, prepaid credit cards refer to cards pre-funded with a set limit, rather than being tied to a traditional line of credit. Prepaid debit cards provide access only to funds loaded in advance, which are not drawn directly from a bank account. Prepaid cards may be presented in either physical or virtual formats. Physical prepaid cards may be designed as contact-based cards, which require insertion or swiping at a payment terminal, or as contactless cards, which utilize radio-frequency identification (RFID) or similar technology to complete transactions by tapping near a compatible reader. Virtual prepaid cards provide digital access to prepaid value and are commonly used for online transactions.

The prepaid cards can be linked to a digital wallet, enabling seamless interaction between the card and the wallet. This linkage allows users to transfer funds from the prepaid card into the digital wallet, thereby funding the wallet and expanding its available balance for electronic transactions, online purchases, or peer-to-peer payments. Conversely, the digital wallet may be used to send funds to the prepaid card, effectively reloading the card and making additional funds available for in-store or online purchases where the card is accepted. This bidirectional functionality supports enhanced financial flexibility, enabling users to manage their balances across multiple payment platforms and ensuring easy access to their funds as needed. The integration between prepaid cards and digital wallets typically uses secure protocols to ensure the safety and accuracy of fund transfers. The present disclosure may use a gift card as an example of the prepaid cards, but can be applicable to other types of prepaid cards.

Users may purchase prepaid cards and/or load value to the prepaid cards, for example, at a point of sale (POS) device that is installed with a card reader. During the “load” or activation event for the gift card provider, the card unique identifier (pUID) and associated account could be recorded. Storage of the counter would invalidate any messages recorded from the gift card prior to purchase.

For card registration, a card tap function enables users to initiate the registration process by simply tapping the gift card against a compatible payment terminal or device. This action launches the gift card issuer's website, directing the user to an online portal specifically designed for account creation and card registration. On the issuer's website, the user is prompted to create a personal account and register the unique details of the gift card. During this process, the user provides contact information such as a phone number and/or email address, which is then associated with the gift card. Tying contact information to the card ensures that the user receives notifications if any changes are made to their registered contact data, enhancing account security and enabling timely responses to unauthorized modifications. In addition to initial registration, the website offers features for comprehensive account management. Users can monitor transactions associated with the gift card, reviewing purchases and other activity. If any suspicious or unauthorized transactions are observed, the user has the option to dispute or challenge them as fraudulent directly through the website. Furthermore, the user is given the ability to add value to the gift card by various funding methods, such as Automated Clearing House (ACH) transfers, credit card payments, or other available options. This allows for ongoing use and replenishment of the gift card balance, enabling continued spending and convenient management of prepaid funds.

For card transactions (e.g., card-not-present transactions such as online transactions), two options are provided by the present disclosure for verifying the possession of the gift card by the user. The first option can have merchants require 3D Secure (3DS) for online gift card transactions, which is a security protocol that verifies the identity of a person and validates online card transactions designed to reduce the risk of fraud, identity theft, and other illegal activities.

3D Secure (3DS) operates by utilizing a three-domain model to structure the authentication process for online card transactions. Each domain represents a key party or infrastructure element involved in securing and validating the transaction. The acquirer domain consists of the merchant and the acquirer, which is the bank or financial institution responsible for processing payments on behalf of the merchant. This domain initiates the transaction request and transmits the purchase information to the other domains for further action. The issuer domain pertains to the cardholder's issuing bank, which is the financial institution that issued the payment card used in the transaction. Within this domain, the cardholder's identity is authenticated, commonly through password verification, biometrics, or other methods. The issuer domain also assesses transaction risk and grants authorization based on user credentials and transaction behavior. The interoperability domain includes the systems, networks, and protocols that facilitate communication between the acquirer and issuer domains. This typically involves payment networks (such as Visa or Mastercard) and dedicated 3DS servers that securely handle data exchanges needed for authentication and authorization. By segmenting responsibilities across these three domains, 3DS enhances the security of online card transactions. It provides a layered approach to authentication, helping to protect cardholders and merchants from payment fraud. During a 3DS transaction, the user is prompted to verify their identity with the card issuer. This is usually done by entering a password linked to the card or a code sent to the user's phone. 3DS is optional in some regions, but it can be used as a tool to reduce fraud. The gift card issuer requires that a challenge for verifying the gift card has to be via email or other means of communication if a phone number of the user is not available.

In embodiments, a first option provided by the present disclosure is for online merchants accepting gift cards and the associated payment processors to determine if they route the transaction down a 3DS flow. Some gift card issuers may enable online merchants to send gift cards transactions down the 3DS flow—but it is unclear (except in the case of a registered card) how a challenge for verifying the gift card would work in this instance, since the issuer of the gift card won't have the user's phone number.

In embodiment, a second option provided by the present disclosure for verifying the possession of the gift card by the user can be to work with prepaid card, gift card, and/or other third party card issuers or servicers to use the systems and methods described herein plus an encryption technology (e.g., 3DS). In some embodiments, gift card issuers and/or providers can work with merchants to surface the tap experience (to prove card presence) when the card is being used online.

The present disclosure provides a prepaid card with enhanced data security for preventing fraud on the prepaid card. The present disclosure can further provide systems and methods for controlling fraud on a prepaid card. For example, the prepaid card provided herein can be a gift card with technical capabilities as discussed herein.

The software necessary to perform the functions described herein can be placed on the prepaid card when it is issued. At the time of purchasing the prepaid card, the point of sale register has applications installed that contacts the issuer and allocates the funds to the gift card. To prevent the above mentioned fraud from happening, the user is made to perform identity verification as described herein on the gift card before the user can actually use the gift card. For example, in this case, if a fraudulent actor, e.g., a card drainer or spammer, copied the card information in advance, and would attempt to use it, an authentication challenge would be sent via the switchboard network described herein. To initiate the use of a gift card and access the funds loaded onto it, the user is required to physically tap the card against a compatible payment terminal or device. This action activates the card and authorizes its first transaction. The tap function employs contactless technology, typically utilizing near-field communication (NFC) or radio-frequency identification (RFID) protocols, which allow communication between the card and the terminal without the need for physical insertion or swiping. This initial tap serves a dual purpose: it confirms the user's intent to use the card and formally activates the card for transactional activity. Only after this action is completed can the user access the preloaded funds and conduct purchases or payments with the card. The requirement for a physical tap adds a layer of security, ensuring that the first transaction occurs only upon direct user interaction, thereby reducing the risk of unauthorized usage before activation.

Because the fraudulent actor does not possess the gift card (they only have stolen card information), the fraudulent transaction can not proceed. In addition to preventing the unauthorized use of funds, this has advantageously can alert the user, card issuer, and/or payment processor that a fraud is occurring. In this manner, a card present transaction is necessary for the first use of the gift card.

In contrast, many conventional gift cards are not chip-enabled and are used in online transactions. For such conventional gift cards, a user may only need to fill the PAN and the CVV from a conventional gift card into an online checkout form. Then a 3DS challenge for verifying the customer may be performed. However, the problem with the 3DS challenge is that it has to know who to send the challenge to and accordingly 3DS does not work for these conventional gift cards because the real owners of these conventional gift cards are unknown (and thus their contact information is unknown) except that the conventional gift card and the user's contact information are registered with the gift card issuer or a payment processing network. Some conventional gift cards may have a quick response (QR) code on the package, suggesting to a user to register their gift card to protect it. However, the user may consider this extra step of registering the gift card as a pain, and thus does not like to do so.

In the present disclosure, the prepaid card provided herein can use the techniques described herein to have at least a contactless interface to make the provided gift card work for verifying a user and preventing fraud. For example, when a user taps the gift card provided by the present disclosure, especially if the user uses the tap to launch card functionality, the customer can actually launch to a website (e.g., the card issuer's website). And then the user can check the website to see if there was a pending transaction on that gift card, because the pUID of the message of the gift card is associated with the preregistered PAN for that gift card. If there was a pending transaction on the gift card, the user can then activate the gift card right away or approve the transaction. This can be repeated for every transaction, if desired to do so.

The gift card provided by the present disclosure can be provided with the air key information, and/or a separate applet. For example, the gift card may be provided with an EMV applet so the gift card can be used in a POS terminal as a chip card. The gift card provided herein can be used for online transactions. For example, a merchant can submit the transaction information to their acquirer, and the acquirer then forwards it to the transaction processing network, then the network can contact the issuer of the gift card to verify the user of the gift card. In this case, the gift issuer have produced the card in advance, and would maintain a correlation between the pUID from the card and the PAN that is on the prepaid gift card. When the card issuer receives the PAN authorization, the issuer can check the status of the gift card. For example, the card issuer may respond that this gift card hasn't been used yet, and a tap of this gift card is required. The user may tap the gift card to, for example, his mobile phone on which a corresponding application is installed, which can activate the card or approve the transaction.

In some embodiments, before a first transaction on the gift card, the user may follow the instructions provided on the gift card to tap the card to his mobile phone, and then, the tap would launch the gift card website and start the user on the registration for that card. The registration for the card would be specific to that card because it would have a pUID mapping as discussed herein, which enables a lookup. During the registration, the user can provide his contact information, such as a phone number, email address, and/or mailing address. By this way, a merchant can have that channel back to the user, so that 3DS can be performed when transactions on that card occur. That is, in order to activate the gift card, after purchasing it, the customer is required to tap the card into his mobile phone, and then register it with his phone number. And then after that, the transactions can all be verified with that user.

In some embodiments, software, such as applets, that perform the functions described herein can be preloaded onto blank cards, and in some embodiments can be inactive for activation at a later time. In embodiments, different options can allow for activating (or inactivating) the software.

The first option can include preload an inactive applet on a gift card. When a user validates the inactive applet, and it would fail because the card issuer is not registered with the processing network system. The user can also know through a user interface of a mobile phone or other user device, that there will be cards that fail to activate or be used, because, for example, some issuers have cards that aren't fully in the processing network system yet. In this case, when a customer taps the card to his mobile phone to activate the card, a message authentication code (MAC) mechanism can be used to attempt to activate the card. For example, a near field data exchange (NDEF) message with the MAC can be written to activate the card. Specifically, one of the control bits of the NDEF message is used to activate the card. A pUID can be presented, and then a blank cryptogram, e.g., a zero cryptogram, can also be generated. The user can then tell the card is not active, and this card is not valid without going through the network. This may preserve the card issuer's privacy, for example, how many of their cards are attempting to go through the network, or if the card issuers are signed up with the network. In this option, an NDEF applet is on the card, and is visible. And the NDEF can produce message, but is not message that is valid. It can be detected earlier because the cryptogram has a specific value. It has a 0 value or any specific value, but that is not likely to occur in a regular encryption.

In another option, the cards can be configured in such a way that a card does not respond with the NDEF applet ID when the card is tapped to a mobile phone. There have an alternate applet ID on the card. The alternate applet supports the same protocol and everything like that as the NDEF applet. The alternate applet is an alias essentially for the NDEF applet. When an application on the mobile phone is sending out messages to the card for selecting NDEF applet ID, it would never work. It would never select the NDEF Applet, because the NDEF applet doesn't respond until it's activated. In this case, the alternate applet ID acts as a shadow applet ID, and then the application on the mobile phone can specifically select that alternate applet ID instead of the NDEF applet ID to perform the protocol to write the NDEF control bits. Once the NDEF control bits are written, then the NDEF applet is now activated, and optionally, the alternate applet can be deactivated. In this way, the card is made fully live and fully active. The alternate applet can be fully personalized to act as an alias of the NDEF applet, and can have a shadow interface allowing the user to access the application.

In some embodiments, the prepaid card can be linked to a digital wallet for funding the digital wallet. Described herein is a system for a multi-institution digital wallet browser extension. The browser extension is used to implement a digital wallet for executing online transactions. In some embodiments, the browser extension can be installed on a user's browser simultaneously with a mobile banking application for the bank. That is, when a user downloads the mobile banking application, or other type of banking software application, the browser extension can be simultaneously downloaded onto the browser of the computing device on which the banking application is downloaded. The browser extension allows the multi-institution digital wallet to operate on the computing device, such as a mobile device, or other computing device. In the banking application, users can enroll to use the multi-institution digital wallet extension and this will cause a first hypertext transfer protocol (HTTP) cookie to be shared with the browser of the user's mobile device and the browser extension. This HTTP cookie creates a device binding or trust between the user's mobile device (or other device operating the application and browser) and a centralized digital wallet server. Users that download a desktop version of the browser extension may complete a similar procedure to enroll after logging in with their bank credentials in the desktop browser and create a device HTTP cookie for the desktop as well. The HTTP cookie may also be referred to herein as a “temporary browser data file” or a “browser data file.” The HTTP cookie (e.g., “temporary browser data file” or “browser data file”) can be generated by the bank server described below (e.g., the server that works as the backend to the mobile bank application described herein) and shared with the browser extension, or the HTTP cookie (e.g., “temporary browser data file” or “browser data file”) can be generated by the centralized digital wallet server described below.

Additional embodiments address the secure management of applets installed on contactless cards in general, such as credit, checking, or savings cards. These applets are initially placed in a dormant, factory-shipped state, which means they are inert and unable to execute their primary transactional or authentication functions. Maintaining the applet in an inactive state ensures security, as it cannot be exploited or perform unintended operations prior to authorized activation.

Transitioning the applet from this dormant state to an active and fully operational one occurs through a post-issuance activation process. This activation is implemented as a one-time event and is protected using cryptographically secure protocols. The process is designed to ensure that only authorized users or systems can activate the applet, safeguarding against unauthorized activation attempts or tampering.

Upon activation, the applet enables its designated NFC Data Exchange Format (NDEF) functionality, supporting secure contactless communication for operations such as payments, access control, or data transfer. This architecture allows card issuers to distribute inactive cards, mitigating risk, and subsequently activate full functionality only after validating the recipient, thereby maintaining rigorous security standards throughout the process.

One challenge is to design an activation protocol that is both secure and user-friendly, balancing the need for cryptographic verification against the accessibility of the activation mechanism (e.g., native mobile app vs. web browser). One embodiment may include activation via a “Shadow” Application ID (AID). In this embodiment, the applet is manufactured to be completely invisible to standard NDEF discovery mechanisms. It achieves this by not responding to the standard NDEF AID. Instead, it listens exclusively on a proprietary, non-standard “Shadow” AID known only to a trusted activation application.

In this embodiment, in the initial state, the applet is configured to be non-responsive to selection by the standard NDEF Application Identifier (AID), e.g., D2760000850101. This implies that, when an NFC-enabled device—such as a smartphone—attempts automatic tag discovery by searching for standard NDEF applications, the applet will remain undetectable and cannot be interacted with using conventional NDEF protocols. This behavior ensures that the applet cannot be accessed or exploited through commonly available NFC-reading tools or devices while in its dormant state.

Instead of using the standard NDEF AID, the applet is programmed to recognize and respond to a proprietary “Shadow” AID, for example, F123456789ABCDEF. This unique identifier allows authorized systems or personnel to communicate with the applet using non-standard methods, effectively hiding the applet's functionality from general NFC queries. Within this state, applet functionality is strictly limited. The only permitted operations are read and write access to the applet's internal NDEF file, conducted exclusively via the Shadow AID channel. No other applet functions are accessible, and standard NFC-enabled phones or readers cannot interact with the applet or access its stored data unless they are explicitly configured to use the proprietary Shadow AID. This approach maintains the security and integrity of the applet prior to its formal activation.

The activation protocol is managed by a specialized native mobile application equipped with knowledge of the proprietary Shadow AID. This application establishes a secure session by deliberately selecting the applet via the Shadow AID, thus insulating the activation process from standard NFC discovery mechanisms and unauthorized readers.

Upon establishing communication, the mobile application issues an NDEF READ command specifically over the Shadow AID channel. The response from the applet's internal NDEF file includes key identifiers: Issuer ID: identifies the entity that originally provisioned the applet, enabling issuer-level traceability and security, Key ID: indicates the version or specific instance of the cryptographic key required for the activation process, ensuring key management continuity, Platform Unique Identifier (PUID): serves as a serial number, offering unique identification for each applet instance.

The mobile application sends these identifiers to a centralized switchboard system or service which operates as a directory-based router. The switchboard system uses the Issuer ID to select the correct issuer endpoint and securely forwards the activation request. Upon receipt, the issuer's cryptographic service utilizes the associated master key, identified by the Key ID, to generate a unique, one-time Control Message Authentication Code (MAC). This MAC is computed over the PUID and other pertinent data and acts as a secure activation credential. Activation may also be perform by communicating the identifiers directly to a server operated by a banking system, e.g., without being routed through a switchboard system.

The application receives the Control MAC from the issuer. It then prepares an NDEF WRITE command containing: the calculated Control MAC, control bits indicating the instruction for state transition, and transmits this command securely to the applet. On receipt, the applet internally recalculates a MAC using its own secret key and the supplied activation data. If the internally derived MAC matches the received MAC, the applet authenticates the request, then securely transitions to an “Active” operational state. In this new state, the standard NDEF AID is enabled for general NFC interactions, and the Shadow AID is permanently disabled to prevent further unauthorized access.

If the MACs do not match, the activation fails, and the applet remains inactive, ensuring that only legitimate cryptographic requests can trigger the transition to active status. This protocol enforces robust security for card activation and mitigates risks associated with unauthorized access or replay of activation data.

In this embodiment, one key advantage is the high security afforded by the approach: the applet is completely “dark” to unauthorized users and automated scans, which effectively prevents any interaction with the applet before it has been properly activated. Additionally, the process is tightly managed by a dedicated and trusted native application, providing a highly controlled environment for the activation flow and ensuring that only authorized procedures are followed.

In embodiments, include applet activation via NDEF Read with a Fixed Cryptogram. In this embodiment, the applet is discoverable via the standard NDEF AID from the beginning but signals its inactive state using a predictable, non-valid value in its response.

In this configuration, the applet is accessible and responds to selection by the standard NDEF Application Identifier (AID), making it visible to NFC-enabled devices and applications adhering to standard protocols. Upon receiving a read request, the applet generates a structurally valid NDEF message. This message includes key identifiers such as the IssuerID (identifying the card issuer), KeyID (specifying the cryptographic key version), and PUID (the unique serial number of the applet instance). However, the cryptogram segment of the NDEF message—where a secure, encrypted Message Authentication Code (MAC) would normally be found—is replaced with a predetermined, non-secure value (e.g., all zeros). This ensures that any system or reader attempting to verify the authenticity of the applet using the cryptogram will consistently encounter a failed validation, marking the tag as invalid or unauthenticated. Consequently, the applet does not allow access to its primary or sensitive functions in this state. Only after successful activation, wherein a legitimate cryptogram is provided and authenticated, will the applet transition to an operational mode and enable its intended NFC functionality. This mechanism maintains a balance between accessibility for activation and security against unauthorized use.

In this example, the activation protocol is invoked by any NFC-capable client, including both native mobile applications and web applications utilizing WebNFC. The process begins with the client performing a standard NDEF READ operation to discover and interact with the applet. Upon retrieving the NDEF message, the application extracts the IssuerID, KeyID, and PUID fields. It then inspects the cryptogram segment; if this field contains the fixed, inactive value (e.g., all zeros), the application determines that the applet requires activation.

Next, the client verifies whether it is authorized to activate cards from the identified issuer by consulting an issuer list. If authorized, the client routes the collected identifiers to the corresponding issuer's cryptographic service endpoint. The issuer's service then computes a Control Message Authentication Code (MAC), along with any necessary control bits, using a securely stored master key and the provided data—this step mirrors the cryptographic challenge process as discussed above.

The client application receives the Control MAC and activation bits, and issues an NDEF WRITE command to the applet's NDEF file, transmitting the activation data. The applet internally validates the received MAC; if the MAC is correct, the applet updates its internal state to “activated.” From this point forward, the applet returns a valid, dynamically computed cryptogram within its NDEF messages upon each read operation, thus functioning as an active and authenticated applet. If the MAC validation fails, the applet rejects the write command and remains in its inactive state, preventing unauthorized activation and protecting against fraudulent access attempts.

This embodiment offers significant advantages in terms of accessibility. Activation can be initiated by a variety of NFC-capable clients, including web browsers through WebNFC, enabling users to activate cards with a simple “tap-to-activate” approach without needing to install a proprietary application. Client logic is streamlined, as there is no requirement to recognize or process proprietary AIDs; all necessary communication occurs via standard NDEF read and write operations, simplifying integration.

The selection between these two embodiments hinges on the balance between security requirements and user experience. Embodiment 1 (Shadow AID) provides maximum pre-activation concealment and strictly limited activation flows by hiding the applet from standard NFC discovery. It is optimal for enterprise or high-security scenarios where controlling every facet of activation is critical, and the requirement for users to install a dedicated native application is acceptable. Embodiment 2 (Fixed Cryptogram) prioritizes accessibility and ease of use, allowing activation through standard NFC interactions supported by both native and web-based applications such as WebNFC. This enables frictionless “tap-to-activate” user experiences, making it better suited for broad consumer applications where minimizing barriers to usage is crucial. While the applet is visible prior to activation, robust cryptographic controls remain in place to secure the final activation step, maintaining a strong security posture suitable for mainstream deployments.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For IOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, desirable, or even possible in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

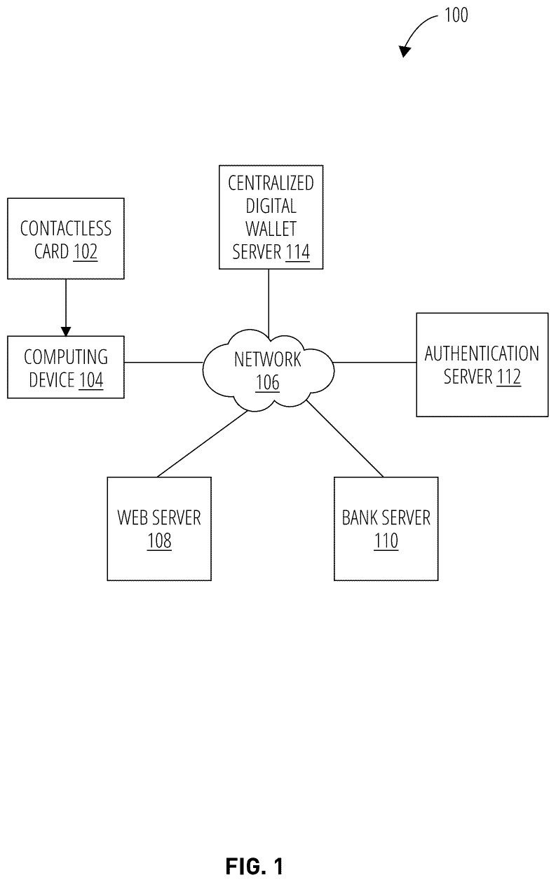

FIG. 1 illustrates system 100 for providing a multi-institution digital wallet browser extension according to an example embodiment. As further discussed below, system 100 may include contactless card 102, computing device 104, network 106, a web server 108, a bank server 110, and authentication server 112, and a centralized digital wallet server 114. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with computing device 104. As described below, the contactless card 102 may provide one factor of authentication to authenticate an identity of the user of the computing device 104 to approve a usage of the digital wallet browser extension.

System 100 may include computing device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Computing device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The computing device 104 can include a processor and a memory, and it is understood that the processing circuitry may contain additional components, including processors, memories, error and parity/CRC checkers, data encoders, anticollision algorithms, controllers, command decoders, security primitives and tamper proofing hardware, as necessary to perform the functions described herein. The computing device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, computing device 104 of system 100 may execute one or more applications, such as software applications, that enable, for example, network communications with one or more components of system 100 and transmit and/or receive data.

The computing device 104 may be in communication with one or more servers such as a web server 108, a, bank server 110, an authentication server 112, and/or a centralized digital wallet server 114 via one or more network(s) 106, and may operate as a respective front-end to back-end pair with any of those servers. The computing device 104 may transmit, for example from a mobile device application (e.g., a browser) executing on computing device 104, one or more requests to web server 108. The one or more requests may be associated with retrieving data from web server 108. The web server 108 may receive the one or more requests from computing device 104. Based on the one or more requests from computing device 104, web server 108 may be configured to retrieve the requested data from one or more datastores (not shown). Based on receipt of the requested data from the one or more datastores, web server 108 may be configured to transmit the received data to computing device 104, the received data being responsive to one or more requests. This may include loading a webpage from the web server 108, for example, a webpage for performing an Internet transaction.

System 100 may include one or more networks 106. In some examples, network 106 may be one or more of a wireless network, a wired network or any combination of wireless network and wired network, and may be configured to connect computing device 104 to web server 108, bank server 110, authentication server 112, and centralized digital wallet server 114. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers, such as web server 108, bank server 110, authentication server 112, and centralized digital wallet server 114. In some examples, each of the servers may include one or more processors, which are coupled to memory. The web server 108 may be configured to host a website for the computing device 104 to access and make one or more purchases thereon. In some embodiments, the web server 108 may include computer code and instructions thereon for hosting the website and for communicating website data to the computing device 104 so the computing device 104 can download and access the website. Functionality of the web server 108 is discussed in greater detail below.

The bank server 110 may be a server controlled by a financial institution. The bank server 110 may host a banking application which the computing device 104 can download, and the computing device 104 and the bank server 110 operates as a backend to frontend pair for the banking application. Additional functionality of the banking server is provided below.

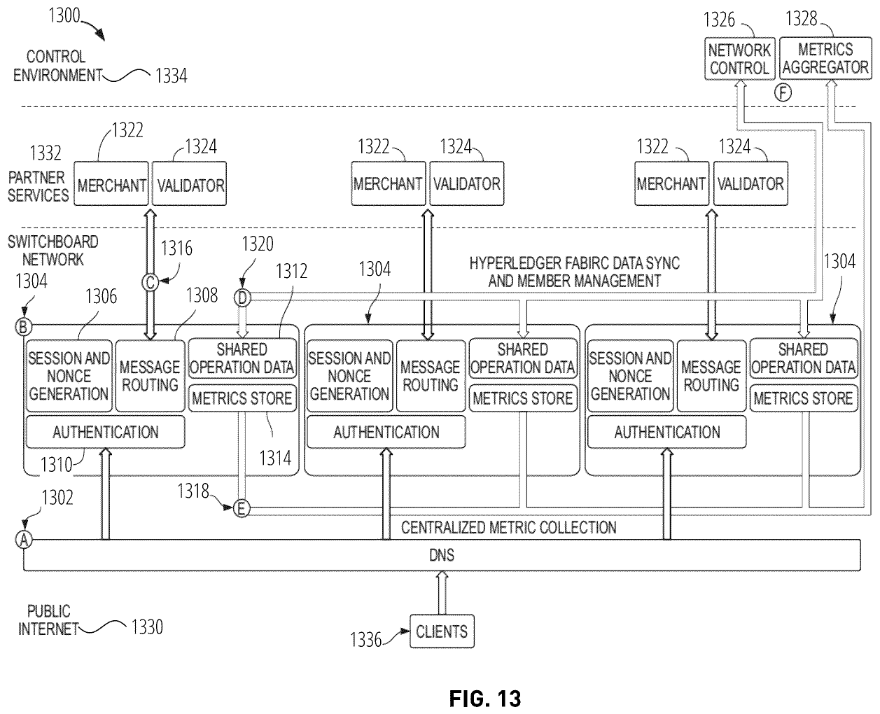

The authentication server 112 is a server that can be, for example, hosted in the system 1300 shown below in FIG. 13. For example, the authentication server 112 can be a node 1304 of the switching system 1300 described in FIG. 13. The authentication server 112 can operate to provide authentication services for the user. For example, in some embodiments, the authentication server 112 can receive and decrypt encrypted data from the contactless card 102 to act as a validation system of the identity of the user of the computing device 104 and therefore provide a factor of authentication for the digital wallet browser extension system described herein.

The centralized digital wallet server 114 is a central server that can, for example, host personal identifying information (PII) and payment information (e.g., virtual card numbers (VCNs) and/or bound VCNs (BVCNs) for corresponding user accounts associated with the centralized digital wallet server 114. The centralized digital wallet server 114 can communicate the PII and VCNs or BVCNs to a browser extension downloaded onto the browser of the computing device 104. The centralized digital wallet server 114 can perform various other functions described in more detail below.

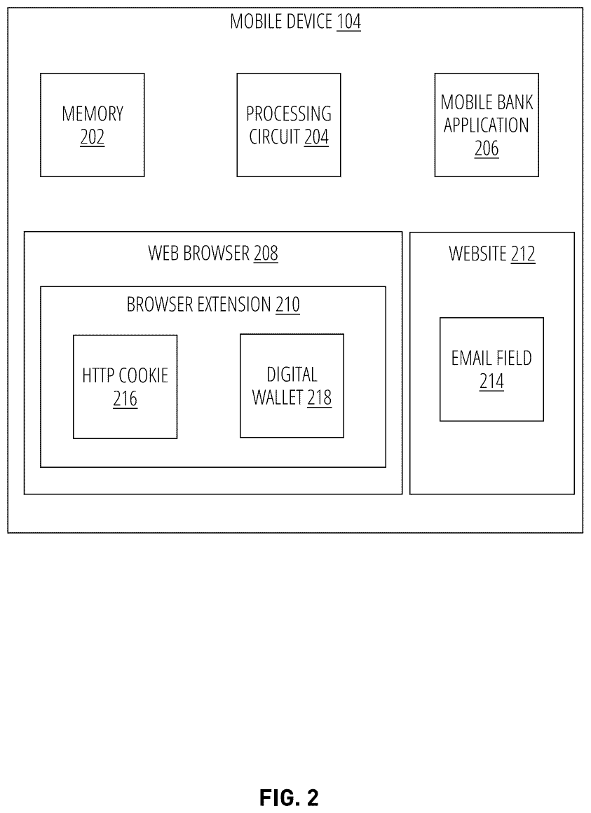

FIG. 2 is a block diagram illustrating an example computing device 104 according to some embodiments of the present disclosure. In some embodiments, the computing device 104 includes a memory 202 storing executable instructions thereon. The computing device 104 further includes a processing circuit to execute the instructions of the memory 202, which when executed, cause the processing circuit to perform various operations described herein.

In some embodiments, the computing device 104 has a web browser 208 installed thereon. For example, the web browser 208 can be a mobile version of the Safari web browser by Apple, Google Chrome by Alphabet, Mozilla Firefox or any other suitable browser. In some embodiments, the computing device 104 can communicate with a central application download store (e.g., App Store or Android App Store, Microsoft App Store, or any other suitable application download store) to download a mobile bank application 206 to communicate with the bank server 110. For example, the mobile bank application 206 can be a banking application that allows the user to access the bank account information from the bank server 110. In some other embodiments, the bank server 110 is a credit card company server and the mobile bank application 206 is a credit card application that provides the user access to their credit card account information. In some embodiments, instead of downloading the application from the app store, the mobile bank application 206 may be downloaded directly from the bank server 110. For example, in some embodiments the computing device 104 is another computing device such as a personal or desktop computer and the personal or desktop computer is configured to communicate with the bank server 110 to download the mobile bank application 206.

In some embodiments, the computing device is configured to automatically install a browser extension 210 on the web browser 208 operating on the computing device, the browser extension 210 being associated with a bank with which a user of the computing device has a banking account, the browser extension 210 enabling operation of a digital wallet associated with the bank to operate on the computing device. In some embodiments, the mobile bank application 206 and the browser extension 210 are downloaded and installed on the computing device substantially simultaneously. For example, in some embodiments the user can initiate a download of the mobile bank application 206 to install it on the computing device, and as part of the download of the mobile bank application 206, the browser extension 210 is also downloaded onto the web browser 208. In some cases, the browser extension 210 can be part of a file download package that comes with the mobile bank application 206 and as part of the sequence of downloading the mobile bank application 206, the browser extension 210 is also installed.

In addition to the browser extension 210 being installed, when the user enrolls in the multi-institution digital wallet extension, a temporary browser data file (e.g., an HTTP cookie 216) is also stored within the web browser 208 to permit the browser extension 210 to automatically populate at least one entry field described below with the personal data again at a future time. The HTTP cookie 216 (e.g., “temporary browser data file” or “browser data file”) can be generated by the bank server bank server 110 and shared with the browser extension 210, or the HTTP cookie (e.g., “temporary browser data file” or “browser data file”) can be generated by the centralized digital wallet server 114 and shared with the browser extension 210.

After the user has installed the browser extension 210 the user can set up one or more payment methods (e.g., credit cards) with the browser extension 210 that are sent to the centralized digital wallet server 114 to store and associated with the user's account to operate in the digital wallet 218. In some embodiments, the user may have multiple forms of payment saved and each one has a corresponding mobile bank application 206 associated there with. However, the browser extension 210 is only downloaded once when the first mobile bank application 206 is downloaded. The browser extension 210 is not installed each time a new mobile bank application 206 is installed.

In some embodiments, the computing device is configured to access a website 212 (e.g., hosted on the web server 108) via the web browser 208, the website 212 including a webpage having at least one entry field to be filled with data. For example, the website 212 can be a website for commercial transactions where the user can purchase goods and services online. The processing circuit 204 (e.g., one or more microprocessors and related components) is caused to enable operation of the digital wallet by activating the browser extension 210 on the web browser 208, the browser extension 210 being associated with the bank with which the user of the computing device has a banking account.

The website 212 includes a checkout page or checkout area or section that can include an email field 214 or any other entry field for which the user may be prompted to enter data. In some embodiments, the user selects the email field 214. Upon selecting the email field, the user is prompted by the browser extension 210 to indicate (e.g., via a user interface of the computing device 104) whether the user would like to use the browser extension 210 to execute the payment information for the checkout of the transaction. In response to the user indicating that they do want to use the browser extension 210 to perform the transaction (e.g., by selecting confirmation on the user interface of the computing device 104), the mobile bank application 206 is launched by the processing circuit 204.

When the browser extension 210 prompts the user to select whether they want to use the browser extension 210 to perform the transaction, the browser extension 210 is caused to display a prompt for the user to select a payment method form a list of one or more payment methods saved within the digital wallet 218. The one or more payment methods can include one or more payment options (e.g., credit or debit cards) that the user set up in the centralized digital wallet server 114. For example, the user is prompted to select, on a user interface of the computing device 104, a contactless card listed as one of one or more payment methods such as the one or more payment options described above. The user is directed to select one of the payment methods or credit cards that is saved on file at the centralized digital wallet server 114. The processing circuit 204 then receives, as input from the user via the user interface (not shown) of the computing device 104, a selection from the user for one of the payment methods.

Based on the payment method or credit card selected, the centralized digital wallet server 114 directs the browser extension 210 to cause the appropriate mobile bank application 206 to be launched. That is, the mobile bank application 206 that is executed or launched corresponds to the bank or issuer associated with the payment method selected by the user. For example, if a credit card issued by “ABC Bank” is selected by the user, the corresponding mobile bank application 206 for “ABC Bank” is launched. When the mobile bank application 206 is launched, step up occurs. Additionally, the browser extension 210 receives an authentication token (e.g., oAuth token) via a URL from the bank server 110 or the centralized digital wallet server 114. The authentication token is used by the browser extension 210 to make API requests on behalf of the user. The authentication token represents the authorization of a specific application (e.g., the browser extension 210) to access specific parts of a user's data (e.g., the user's personal data and any payment information from the centralized digital wallet server 114). That is the authentication token received by the browser extension 210 allows the browser extension 210 to make an API request to the centralized digital wallet server 114 to receive the PII and VCN or BVCN of the user for the account selected.

Before the authentication token can be received, one or more factor authentication may take place. For example a first authentication can include the mobile bank application 206 displaying a prompt to the user to enter the user's login credentials from the user. The user then enters their username (e.g., email address) and password inside the mobile bank application 206, which is received by the processing circuit 204, which validates the login credentials locally, or sends the login credentials to the authentication server 112 for validation. As another factor of authentication, the browser extension 210 can cause a one time passcode (OTP) to be sent via text message to a phone number associated with the user (e.g., a mobile device of the user). In some embodiments, the computing device 104 is configured to receive as user input into the web browser 208 or the browser extension 210 the OTP, and forward the OTP as the authentication data to the authentication server 112 for validation.

In another example, the processing circuit 204 is configured to prompt the user to authenticate an identity of the user by tapping their contactless card 102 to the computing device 104. In such an embodiment, the user can tap the contactless card 102 (e.g., from the list of payment methods) to the computing device 104, and the contactless card 102 can transmit, via an NFC exchange, encrypted data to the computing device 104. In some other embodiments, the authentication data can include biometric data or the like.

In some embodiments, the computing device 104 is configured to receive the authentication data from the user and then send the authentication data to an authentication server, such as authentication server 112. If the authentication data is a password or biometric data, the password or biometric data is validated by the authentication server 112. If the authentication data is encrypted data from the contactless card 102, the encrypted data is sent from the contactless card 102 to the computing device 104 via an NFC exchange as described herein. The encrypted data, such as that described in message 1600 is transmitted to the computing device 104 and then the computing device 104 forwards the encrypted data to the authentication server 112 for decryption and validation.

Once the authentication server 112 validates the encrypted data or biometric data from the contactless card 102 or computing device 104, the computing device 104 is configured to receive an indication from the authentication server 112 that the authentication data is verified. At this point, the mobile bank application 206 is still launched, but after receipt of an indication that that identity of the user is authenticated and the authentication token is received, the user is then redirected back to the web browser 208 and the website 212 where the checkout window is still waiting. The authentication token is then used by the browser extension 210, along with the HTTP cookie 216, to pull PII and BVCN from the centralized digital wallet server 114. For example, in some embodiments, the browser extension 210 sends a request to the centralized digital wallet server 114 for the PII and BVCN associated with the user. The authentication token is sent in the request and indicates which PII and BVCN should be pulled from the centralized digital wallet server 114 according to the payment method selected by the user.

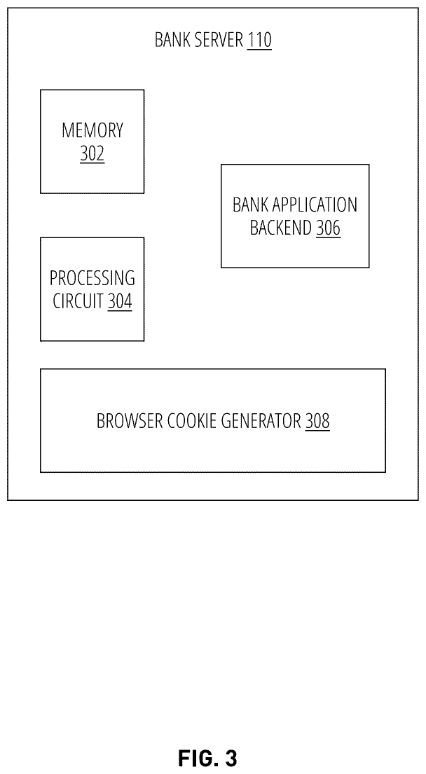

FIG. 3 illustrates a block diagram of an example bank server 110 according to some embodiments of the present disclosure. In some embodiments, the bank server 110 includes a memory 302 and processing circuit 304 to perform various operations described herein. For example, the bank server 110 hosts the bank application backend 306. When the user uses the mobile bank application 206 on the computing device 104, the data populated on the mobile bank application 206 is pulled from the bank server 110 for display. Also, when the user enrolls to operate the multi-institution digital wallet 218, this is performed at the bank server 110. The user will elect to enroll on the bank server 110.

In some embodiments, the bank server 110 includes a browser cookie generator 308. In some embodiments, the browser cookie generator 308 generates the temporary browser data file (e.g., the HTTP cookie 216 described herein). As described above, in the mobile bank application 206, users can enroll in multi-institution digital wallet extension participation in an embedded web object (e.g., SafariController). This creates an HTTP cookie 216 that is shared with the external web browser 208 and the browser extension 210 that has been downloaded to function on the external web browser 208. This unique HTTP cookie 216 generated on enrolled devices creates device binding/trust for the user. Users who download the desktop version of the browser extension 210 complete a similar pattern to enroll after logging in with their bank credentials in the desktop browser and create a device HTTP cookie.

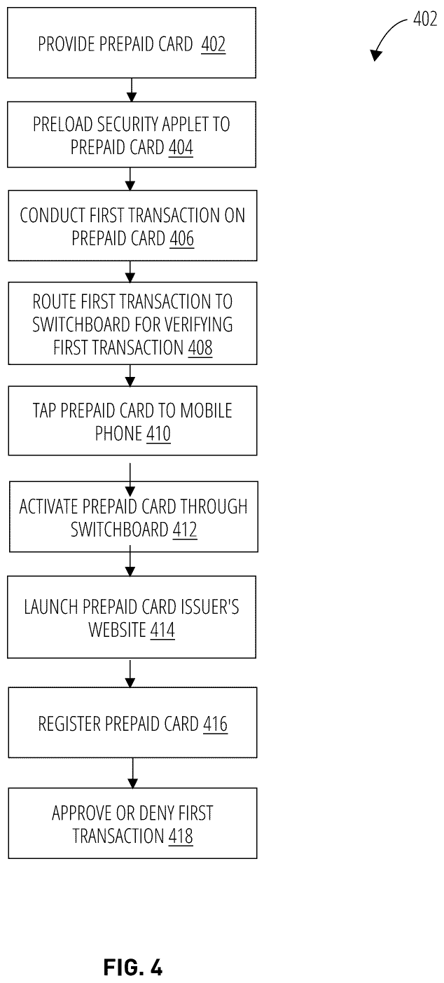

FIG. 4 illustrates a method 1200 performed by a network authentication system for controlling fraud on a prepaid card (e.g., a prepaid gift card) according to an example embodiment. For example, the method 1200 can be performed by the system 100 or by another distributed network authentication system. Specifically, the method 1200 is a method for activating and registering the prepaid card upon a first transaction is performed on the prepaid card.

In block 1202, a prepaid card can be a blank prepaid card manufactured by an issuer of the prepaid card.

In block 404, the prepaid card can be loaded with a security applet for controlling fraud on the prepaid card. The security applet can be loaded by the issuer of the prepaid card or by a third party other than the issuer of the prepaid card, for example, a producer of the security applet.

In block 1206, a first transaction is conducted on the prepaid card with a merchant. The first transaction can be conducted on the prepaid card, but is not completed yet because the first transaction is needed to be verified and/or authenticated. That is, the first transaction is pending. The first transaction can be conducted by a fraudulent actor who stole data information of the prepaid card, such as the PAN number, the CVV value, and/or the expiration date of the prepaid card. The first transaction can be conducted by a user who possesses the prepaid card. The first transaction can be an online transaction or other card-not-present transaction, for example.

In block 408, the first transaction can be routed by the merchant or its acquirer through the switchboard network (as described herein) to the issuer of the prepaid card. The issuer of the prepaid card can recognize the prepaid card through the pUID of the prepaid card that is associated with the bank account of the prepaid card. The issuer of the prepaid card can determine this is a first transaction on the prepaid card waiting for an activation of the prepaid card for approving or denying the first transaction.

In block 1210, the user may tap the prepaid card to his mobile phone on which an application communicating with the prepaid card is installed. The tap can cause the pUID and other card data of the prepaid card to be routed through the switchboard network to the issuer. And the issuer can activate the prepaid card upon receiving the pUID and other card data of the prepaid card. Specifically, the user who possesses the prepaid card can tap the prepaid card to a mobile phone on which an application for operating the prepaid card is installed. The application can communicate with the security applet on the card to confirm the pUID of the card through the above described system. When the pUID is confirmed, the prepaid card is activated.

In block 412, as described above, the prepaid card is recognized and activated through the switchboard network by the issuer of the prepaid card.

In block 1214, the user can proceed to register the prepaid card. For example, upon tapping the prepaid card to the mobile phone, the security applet can automatically launch a website of the issuer of the prepaid card.

In block 416, the user can register the prepaid card on that website, for example, by providing the user's phone number, email address and so on. In embodiments, the user can create an account and provide contact information for notifications relating to the prepaid card and/or the account.

In block 1218, once activating and registering the prepaid card, the user can see the pending first transaction on the website. The user can approve the first transaction if the first transaction is legitimate (e.g., a purchase made by the user) or deny the first transaction if the first transaction is fraud (e.g., the prepaid card information was stolen). Alternatively, the transaction can be approved or denied by the issuer of the prepaid card.

FIG. 13 illustrates a method 1300 performed by a network authentication system for controlling fraud on a prepaid card (e.g., a prepaid gift card) according to an example embodiment. For example, the method 1300 can be performed by the system 100 or by another distributed network authentication system.

Specifically, the method 1300 is a method for activating and registering the prepaid card prior to a first transaction performed on that card.

In block 1302, a prepaid card can be a blank prepaid card manufactured by an issuer of the prepaid card.

In block 1304, the prepaid card can be preloaded with a security applet for controlling fraud on the prepaid card. The security applet can be preloaded by the issuer of the prepaid card or by a third party other than the issuer of the prepaid card, for example, a producer of the security applet.

In block 1306, when a user purchases the prepaid card from a store or online and has fund loaded onto the prepaid card, the user may tap the prepaid card to his mobile phone on which an application communicating with the prepaid card is installed. The tap can cause the pUID and other card data of the prepaid card to be routed through the switchboard network to the issuer. And the issuer can activate the prepaid card upon receiving the pUID and other card data of the prepaid card. Specifically, the user who possesses the prepaid card can tap the prepaid card to a mobile phone on which an application for operating the prepaid card is installed.

In block 1308, as described above, the prepaid card is recognized and activated through the switchboard network by the issuer of the prepaid card. The application can communicate with the security applet on the card to confirm the pUID of the card through the above described system. When the pUID is confirmed, the prepaid card is activated.

In block 1310, the user can proceed to register the prepaid card. For example, upon tapping the prepaid card to the mobile phone, the security applet can automatically launch a website of the issuer of the prepaid card.

In block 1312, the user can register the prepaid card on that website, for example, by providing the user's phone number, email address and so on.

In some embodiment, the user may proceed to conduct a first transaction on the prepaid card. In block 1314, a first transaction can be conducted on the prepaid card with a merchant. The first transaction can be an online transaction. For example, the user may enter the PAN, CVV and expiration date of the prepaid card into a checkout form on a website of the merchant. The first transaction can be conducted on the prepaid card, but is not completed yet because the first transaction is needed to be verified and/or authenticated. That is, the first transaction is pending.

In block 1316, the first transaction can be routed by the merchant or its acquirer through the switchboard network (as described above) to the issuer of the prepaid card. The issuer of the prepaid card can recognize the prepaid card through the pUID of the prepaid card that is associated with the bank account of the prepaid card. The issuer can determine the prepaid card has been activated and registered. The issuer may then generate and transmit a message to the user requesting approving or denying the transaction.

In block 1318, upon receiving the message, the user can approve the first transaction if the first transaction is legitimate (e.g., a purchase made by the user) or deny the first transaction if the first transaction is fraud (e.g., the prepaid card information was stolen). Alternatively, the transaction can be approved or denied by the issuer of the prepaid card.

In some embodiments, after activating and registering the prepaid card, a first transaction and following transactions can be conducted on the prepaid card. In such embodiments, the authentication of the transactions can be performed in different ways.

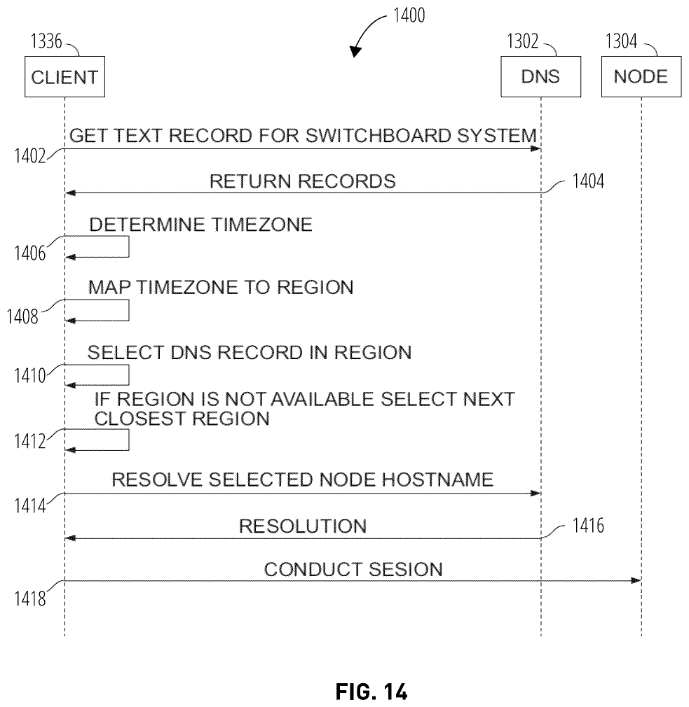

FIG. 14 illustrates a method 1400 performed by a network authentication system for controlling fraud on a prepaid card (e.g., a prepaid gift card) according to an example embodiment. For example, the method 1400 can be performed by the system 100 or by another distributed network authentication system.

Specifically, the method 1400 is a method for verifying transactions on the prepaid card after activating and registering the prepaid card.

In block 1402, after activating and registering the prepaid card, a transaction can be conducted on the prepaid card with a merchant. The transaction can be an online transaction. For example, the PAN, CVV and expiration date of the prepaid card can be entered into a checkout form on a website of the merchant. The transaction can be conducted on the prepaid card, but is not completed yet because the transaction is needed to be verified and/or authenticated. That is, the transaction is pending.

In block 1404, the transaction can be routed by the merchant or its acquirer through the switchboard network (as described above) to the issuer of the prepaid card. The issuer of the prepaid card can recognize the prepaid card through the pUID of the prepaid card that is associated with the bank account of the prepaid card. The issuer can determine the prepaid card has been activated and registered. The issuer may then generate and transmit a message to the user requesting approving or denying the transaction.

In block 606, the user may receive the message from the issuer on his mobile phone that is stored on the issuer's website when the user registers the prepaid card. As said, the message requests the user to approve or deny the transaction.

In some embodiments, the requesting message may include a challenge or a one-time passcode. In block 1408, upon receiving the message, the user can may enter or copy the one time passcode by replying to the message.

In some embodiment, the requesting message may ask the user to tap the prepaid card to his mobile phone. In block 610, the user may follow the instruction to tap the prepaid card to his mobile phone.

In block 1412, the issuer can approve the transaction if the issuer receive the one time passcode from the user or the tap of the prepaid card from the user and can then verify the transaction is legitimate (e.g., a purchase made by the user). The issuer can deny the transaction if the issuer can determine the transaction is fraud (e.g., the prepaid card information was stolen) based on that the issuer did not receive the one time passcode from the user or the tap of the prepaid card from the user.

In some embodiment, the requesting message may include a challenge. For example, the challenge can be a security question, the answer to which can be provided by the user when the user registers the prepaid card. The user may provide an answer to the security question by replying to the requesting message to the issuer. Upon receiving the answer from the user by the issuer, the issuer may determine whether the transaction is legitimate by comparing the answer received from the user and the answer stored on its website. If no answer received from the user, the issuer may deny the transaction.

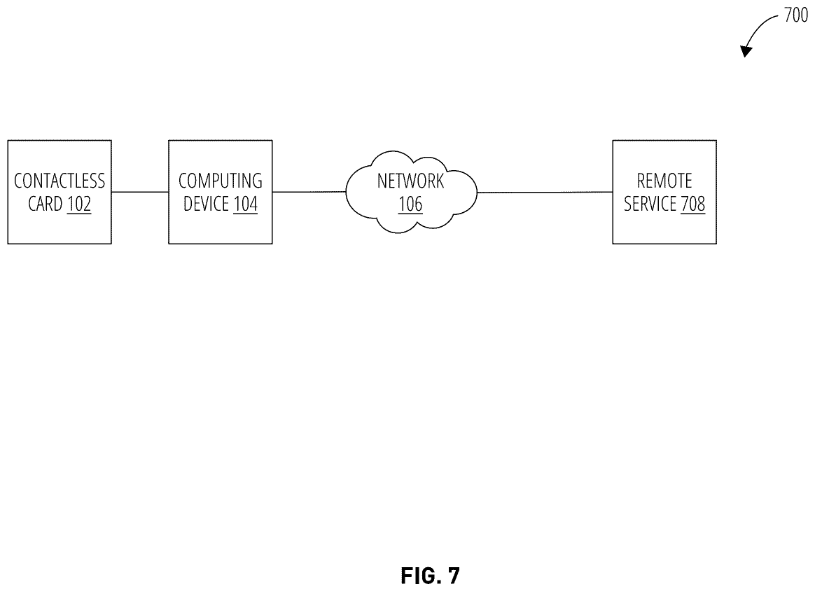

FIG. 7 illustrates an example system 700 in accordance with embodiments discussed herein. For example, the system 700 may utilized to enable an applet on a contactless card. The system 700 includes a contactless card 102, a computing device 104, a network 106, and a remote service 708.

The contactless card 102 may be any type of card discussed herein, such as a payment card, a gift card, a credit card, a debit card, a checking card, a saving card, a badge, an identification card, etc. Moreover, the contactless card 102 refers to any physical card embedded with contactless technology, such as near-field communication (NFC) or radio-frequency identification (RFID), which enables wireless data transmission and communication with compatible readers. In one example, the card is built according to the ID-1 standard form factor (85.60×53.98 mm) and contains an integrated secure microcontroller, an antenna, and optional auxiliary memory components. Compliance with international standards such as ISO/IEC 14443 (proximity cards), ISO/IEC 15693 (vicinity cards), and ISO/IEC 7816 (smart cards) ensures interoperability and security. Embodiments may include PRESTO or AIRKEY technology utilized diversified keys, as discussed herein.

Examples of contactless cards include payment cards (credit, debit, checking, savings), which make use of EMV and contactless protocols for secure financial transactions. These cards store encrypted payment credentials and typically support dynamic data authentication to safeguard against fraud. Cryptographic modules within the card may employ algorithms in addition to diversified key(s) technology such as 3DES or AES for secure data exchange. Gift cards may also utilize contactless technology, allowing for balance inquiry, redemption, and transaction management within proprietary retail payment systems. Similarly, badges or identification cards can leverage NFC or RFID to provide secure access to physical or logical systems. These identification cards frequently store unique user identifiers and may support biometric templates or cryptographic authentication, using secure elements to prevent unauthorized duplication or access. Overall, contactless card 102 encompasses a wide spectrum of applications, unified by their use of wireless, standards-compliant interfaces and robust security mechanisms for protecting user data and enabling frictionless transactions or authentications.

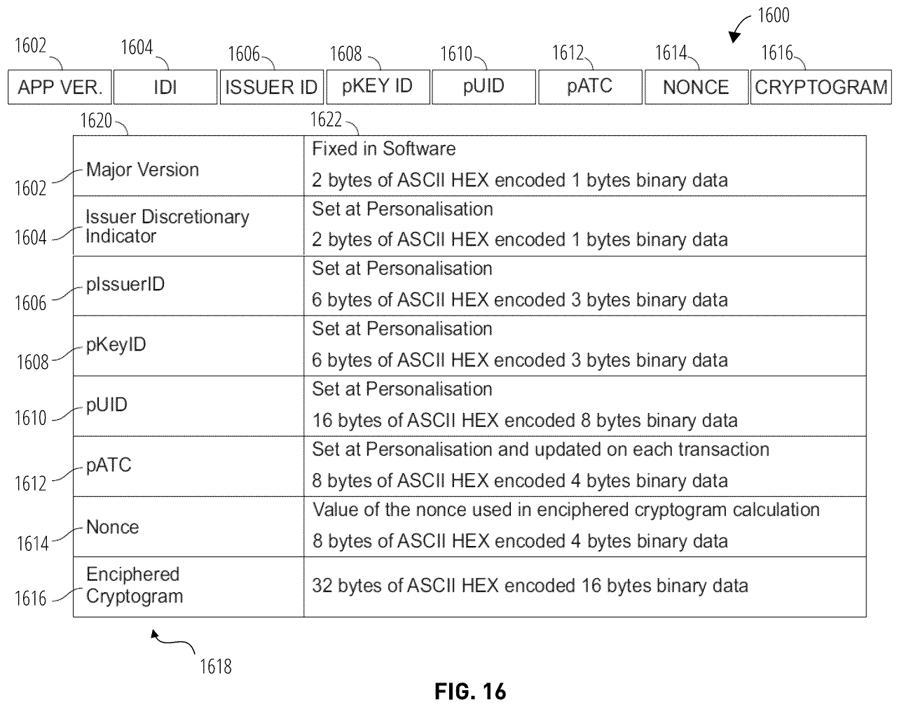

In embodiments, the contactless card 102 may include one or more applets, such as an authentication applet and a transaction applet. In certain embodiments, the contactless card 102 is equipped with one or more applets-self-contained, secure software modules executed on the card's embedded secure microcontroller or secure element. These applets are developed in accordance with Java Card or similar smart card platform specifications, enabling multi-application support while maintaining strong cryptographic isolation and security between applications. An authentication applet is responsible for verifying the identity of the cardholder, the card itself, or both. This applet may implement cryptographic challenge-response protocols based on symmetric encryption (such as DES, 3DES, or AES) or asymmetric encryption (such as RSA or ECC). In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. For example, an authentication message, such as system message 1600, may be generated as discussed in FIG. 16 to perform authentication with a remote service, which may be implemented on a validator 1588 or an authentication server 112. Additional authentication operations may include verifying a personal identification number (PIN), processing biometric data, or performing mutual authentication, where both the card and the terminal must prove knowledge of secret keys before any further action is permitted.

A transaction applet manages the execution of financial or data transactions through secure processing of transaction requests. Its functions may involve generating or validating cryptograms (digital signatures or message authentication codes), updating stored balances, and interacting with the card's persistent memory. For payment cards, the transaction applet adheres to industry standards such as EMV to ensure security, interoperability, and support measures like dynamic data authentication and unpredictable number generation. Multiple applets can operate concurrently within the same card, each secured and isolated by the card's internal operating environment to prevent leaks of sensitive data. The installation, deletion, and lifecycle management of these applets typically follow GlobalPlatform Card compliance procedures. Communication between applets and external systems is conducted using Application Protocol Data Units (APDUs), as defined in ISO/IEC 7816-4, with cryptographic protocols ensuring the confidentiality and integrity of exchanged data. By integrating these applets, the contactless card 102 is capable of securely supporting a broad range of functions beyond basic storage, including authentication, payment processing, identification, loyalty program management, and access control, while maintaining robust security controls.

As discussed herein, the contactless card 102 may be provided with the one or more applets in an inoperable state until they are activated. In one example, the contactless card 102 may be activated by communicating with a remote service 708 via a computing device 104 and network 106. A computing device 104 refers to any electronic device capable of processing data, executing software, and establishing communication with other systems. Examples include desktop computers, laptop computers, smartphones, tablets, servers, point-of-sale (POS) terminals, kiosks, and embedded systems. The device typically comprises a central processing unit (CPU), memory (RAM, storage), input/output interfaces (such as USB, NFC, Bluetooth, or contactless card readers), and an operating system capable of running application software. In the context of contactless card interaction, the computing device 104 is often equipped with an integrated or external NFC or RFID reader, which facilitates wireless communication with the contactless card 102 for tasks such as authentication, transaction processing, or data exchange.

The network 106 represents a communication infrastructure that enables data exchange between the computing device 104, other devices, and remote systems or services, e.g., remote service 708. This network can consist of one or more types of connectivity, including but not limited to local area networks (LAN), wireless local area networks (WLAN or Wi-Fi), wide area networks (WAN), cellular networks (e.g., LTE, 5G), and the Internet. The network supports standard communication protocols (such as TCP/IP, HTTP/HTTPS, or proprietary protocols) to interconnect multiple systems for secure transaction processing, remote authentication, and cloud-based services. Network 106 may also provide connectivity to financial institutions, authentication servers, identity management systems, or remote databases that are involved in processing or verifying information associated with the contactless card 102.

In embodiments, the remote service 708 may be an activation service configured to perform the operations discussed herein to activate the contactless card 102. In embodiments, the remote service 708 may be implemented in a banking system including a bank server 110, and may be routed to the bank server 110 via one or more secure communications via network 106. In another example, the remote service 708 may be implemented in a switchboard system, such as system 1300 in FIG. 13. For example, the remote service 708 may be implemented as part of the validator 1588 or standalone service as a partner services 1332. In embodiments, the partner services 1332 may include a plurality of remote services 708, each associated with a different Issuer. During activation, data to perform the activation may be routed to the corresponding Issuer's remote service 708 via an Issuer identifier, for example.

As discussed, a first embodiment to perform activation may utilize a “Shadow” Application ID (AID). In this embodiment, activation of the contactless card's 102 vapplet is achieved using a proprietary or secret Application Identifier (AID), referred to as the “Shadow” AID. This approach ensures that the applet remains concealed from standard NFC discovery mechanisms. Specifically, the applet is manufactured to ignore requests made by the computing device 104 using the standard NDEF (NFC Data Exchange Format) AID (‘D2760000850101’), which is commonly used by NFC-enabled devices for automatic tag discovery. Instead, the applet is configured to respond exclusively to a Shadow AID, such as ‘F123456789ABCDEF’, rendering it invisible to general-purpose NFC readers and applications.

Upon issuance, the applet resides in an initial “inactive” state on the contactless card 102. In this state, it does not respond to NFC polling with the standard NDEF AID via the computing device 104, effectively preventing accidental or unauthorized access. The applet will only listen for the Select APDU command that matches the proprietary Shadow AID from the computing device 104. All read or write operations to the applet's internal NDEF file structure are restricted to this secure Shadow AID channel by the contactless card 102, ensuring that only authorized activation applications can communicate with the applet at this stage. I

n one example, the activation protocol is orchestrated by a dedicated native mobile application on the computing device 104 that is pre-programmed with knowledge of the proprietary Shadow AID. During activation, the mobile application on the computing device 104 explicitly selects the applet using this Shadow AID and opens a private communication channel. The mobile application then issues an NDEF READ command to the contactless card 102 to retrieve a set of critical identifiers from the applet, including the Issuer ID (which identifies the entity provisioning the applet), the Key ID (which specifies the cryptographic key version for verification), and the PUID (Platform Unique Identifier), a unique serial number for the specific applet instance.

These identifiers are transmitted by the mobile application to a remote service 708, such as a central “Switchboard Service” or partner services 1332 over a secure network channel via network 106. The switchboard system uses the Issuer ID to route the request to the appropriate Issuer's cryptographic backend remote service 708. The Issuer's backend remote service 708 references a securely stored master key corresponding to the Key ID and calculates a unique Control Message Authentication Code (MAC) over the PUID and other relevant data, using cryptographic algorithms such as CMAC based on AES or HMAC with SHA-256. This Control MAC serves as a single-use password for activation.

The remote service 708 may return the Control MAC to the computing device 104. Once the Control MAC is received by the mobile application, the application composes an NDEF WRITE command addressed to the applet on the contactless card 102. This command contains the calculated Control MAC as well as specific control bits that instruct the applet to transition to the active state. The mobile application on the computing device 104 invokes the NDEF WRITE command, and when the applet receives the write command, the applet recalculates the MAC using its own securely stored key and compares it to the provided MAC. If they match, the applet validates the request, transitions its internal state to “Active,” enables the standard NDEF AID for future interactions, and permanently disables the Shadow AID to prevent further use. Conversely, if the MACs do not match, the command is rejected, and the applet remains in its inactive state. Technically, this approach offers enhanced security by separating activation procedures from standard NFC interactions and requiring cryptographic proof of authority for activation. It also facilitates auditability of each step and scalable management for multiple card issuers. Most importantly, the activation process ensures that only trusted, authorized applications can activate the card, thus protecting it against unauthorized reading or tampering before it reaches its end user.

In another embodiment, activation may be performed via an NDEF Read via fixed cryptogram. In this embodiment, the contactless card applet on the contactless card 102 is configured to be immediately discoverable through the standard NDEF AID (‘D2760000850101’). Unlike solutions where the applet is concealed, here the applet responds to NFC Select commands from both native mobile applications and web applications on the computing device 104 using interfaces such as WebNFC. Upon discovery, the applet on the contactless card 102 returns a structurally valid NDEF message that includes key identifiers—IssuerID (identifying the card provisioner), KeyID (specifying the cryptographic key version), and PUID (a unique applet serial number). However, the cryptogram field of this response, which would normally contain an encrypted Message Authentication Code (MAC), is deliberately set to a fixed, known value such as an array of zeros (e.g., ‘0x0000000000000000’). Embodiments are not limited to example, and other fixed, known values may be utilized. This approach signals to any validating system, such as validator 1588, that the tag is present but not yet activated, as cryptographic checks against the fixed value will always fail.

The activation process can be initiated by any NFC-capable client, including native apps or web applications executable on the computing device 104. After performing a standard NDEF READ and receiving the applet's static response, the application on the computing device 104 parses the NDEF payload, extracts the IssuerID, KeyID, and PUID, and checks the cryptogram field. Detection of the predictable inactive value motivates the computing device 104 to proceed with activation. The application then determines whether it is authorized to activate cards for the given IssuerID. If determined to be authorized, the computing device 104 forwards the identifiers to the correct Issuer's cryptographic service endpoint via a secure network connection using protocols like TLS/HTTPS and the switchboard system, e.g., system 1300.

The Issuer's backend remote service 708 accesses a secure master key appropriate for the provided KeyID, typically stored in a Hardware Security Module (HSM) or secure vault. It uses a robust cryptographic algorithm to compute an activation Control MAC over the PUID and any additional required data. Control bits denoting the activation intent are included in the cryptogram payload. The computing device 104 receives this activation data from the remote service 708 and issues an NDEF WRITE command to the applet on the contactless card 102, embedding the valid MAC and control bits.

Upon processing the write command, the applet recalculates the expected MAC using its onboard cryptographic key(s) and matches this with the provided value. If validation succeeds, the applet sets an internal activation flag and transitions to the active state. Subsequent NDEF READ operations will now return a dynamic, valid cryptogram-verifying the tag as authenticated and fully functional. If the MAC validation fails, the applet remains in the inactive state and continues to provide the fixed cryptogram, disallowing further activation attempts. This embodiment provides compatibility with standard NFC infrastructure while maintaining a robust authentication model. It allows flexible activation using both native and web clients, leverages secure cryptographic validation, and supports seamless interoperability and security for a wide range of deployment environments.

In block 802, routine 800 selects, by a mobile application, the applet using a shadow application identifier (AID), wherein in the initial inactive state the applet is configured to respond exclusively to the proprietary AID and not to a standard NDEF AID. The activation protocol is initiated by a dedicated native mobile application that has been specifically programmed to recognize and interact with the proprietary Shadow AID. This app establishes a secure communication channel with the applet, one which is inaccessible to standard NFC readers and automatic tag discovery mechanisms. The process begins with the app explicitly selecting the applet using the Shadow AID.

In block 804, routine 800 reads, by the mobile application from the applet, one or more applet-specific identifiers. Specifically, once this secure channel is established, the app issues an NDEF READ command to the applet. The response contains several critical identifiers: the Issuer ID, which specifies the organization that provisioned the applet; the Key ID, indicating the version or instance of the cryptographic key for authentication purposes; and the Platform Unique Identifier (PUID), an immutable serial number unique to each applet instance.

In block 806, routine 800 transmits, by the mobile application to a remote service, the one or more applet-specific identifiers. These identifiers are then transmitted by the mobile application to a central Switchboard Service. Functioning as a directory, the Switchboard uses the Issuer ID to determine the correct issuer system or server and routes the request to the respective cryptographic service endpoint under secure conditions. Upon receipt, the issuer's cryptographic service, using a master key identified by the Key ID, generates a unique Control Message Authentication Code (MAC) over the PUID and associated activation data. This MAC is engineered as a one-time cryptographic credential to authorize activation.

In block 808, routine 800 receives, at the mobile application from the remote service, a cryptographic authenticator, wherein the cryptographic authenticator is generated by the remote service based at least in part on the one or more applet-specific identifiers and inblock 810, routine 800 sends, from the mobile application to the applet, a write command comprising the received cryptographic authenticator and one or more control bits. The mobile application receives the Control MAC and returns to the applet with an NDEF WRITE command. Contained within this command are the Control MAC and specific control bits indicating that the applet should transition to an active state. Thus, the mobile application communicates this data causing transitioning, by the applet, from the initial inactive state to the subsequent active state in response to a successful validation of the cryptographic authenticator, wherein the transitioning comprises enabling the applet to respond to the standard NDEF AID and disabling the applet from responding to the proprietary AID. Moreover, upon receipt, the applet internally recalculates the MAC using its embedded secret key and the supplied data to verify authenticity. If the recalculated MAC matches the received value, the applet validates the activation request. It then switches its internal mode to “Active,” enabling the standard NDEF AID for subsequent NFC interaction and simultaneously disabling the Shadow AID to prevent reuse or reactivation by unauthorized entities. If the MACs do not match, the applet rejects the request and remains securely in its inactive, dormant state. This approach delivers stringent security guarantees for the activation process and guards against unauthorized commands or replay attacks.

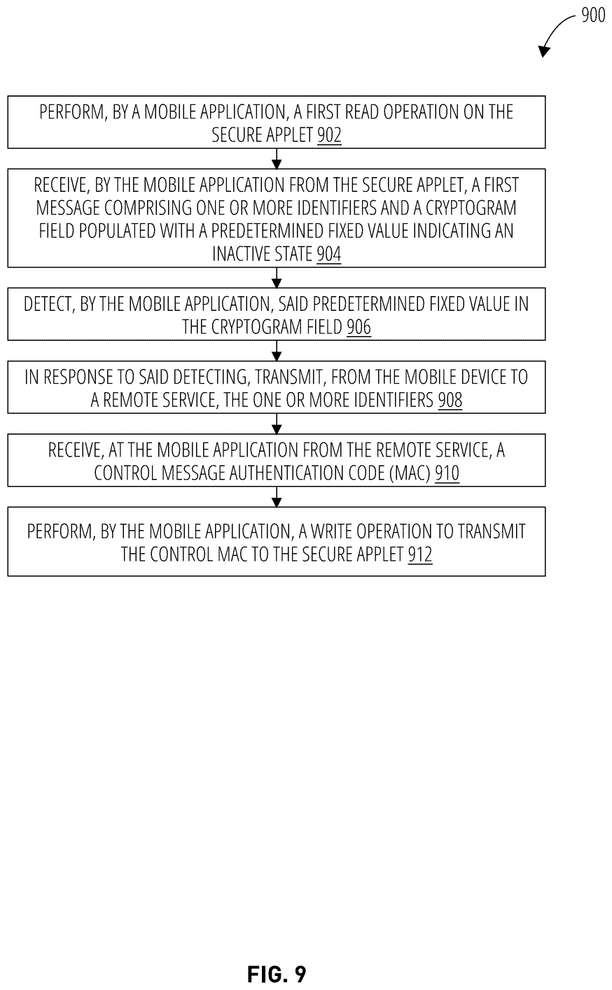

FIG. 9 illustrates a example routine 900 to active an applet on a contactless card. In this embodiment, the applet is immediately discoverable by any NFC reader through the standard NDEF Application Identifier (AID). From the outset, it exposes itself for interaction, distinguishing its inactive state by returning a predictable, non-secure value in place of a valid cryptogram within its response.

In its initial setup thee applet responds to standard NDEF AID selection, allowing NFC-enabled devices or applications to read its data. When queried, it produces a structurally valid NDEF message that contains the IssuerID (identifying the issuer), KeyID (pointing to the cryptographic key version), and PUID (a unique applet serial number). The cryptogram portion, which in an active applet would contain an encrypted MAC to prove authenticity, is instead populated with a fixed value (e.g., all zeros). Consequently, standard authentication systems will find this message invalid when verifying the cryptogram, and treat the tag as unauthenticated. The applet remains unable to perform its core functions until the activation protocol is completed.

In block 902, routine 900 performs, by a mobile application, a first read operation on the secure applet. Activation in this embodiment is highly accessible, as it may be initiated by any NFC-capable client-including dedicated mobile apps or web applications leveraging WebNFC. The client performs a standard NDEF READ, parses the returned message, and inspects the cryptogram field.

Moreover, in block 904, routine 900 receives, by the mobile application from the secure applet, a first message comprising one or more identifiers and a cryptogram field populated with a predetermined fixed value indicating an inactive state, and in block 906, routine 900 detects, by the mobile application, the predetermined fixed value in the cryptogram field.

In block 908, routine 900 in response to the detecting, transmits, from the mobile device to a remote service, the one or more identifiers. Detection of the fixed “inactive” value (such as 0x00 . . . 00) signals that activation is required. The client then verifies if the IssuerID corresponds to an issuer it is authorized to activate for, and if so, forwards the collected identifiers (IssuerID, KeyID, PUID) to the proper cryptographic service endpoint. The issuer's service generates an activation Control MAC and necessary control bits.

In block 910, routine 900 receives, at the mobile application from the remote service, the Control MAC, and in block 912, routine 900 performs, by the mobile application, a write operation to transmit the Control MAC to the secure applet, thereby causing the secure applet to validate the Control MAC and transition from the inactive state to an active state, wherein in the active state, a subsequent second read operation on the secure applet causes the applet to return a second message comprising a dynamically computed cryptogram. Upon receiving this cryptographic data, the client issues an NDEF WRITE command, embedding the valid Control MAC and activation control bits in the command to the applet's NDEF file. The applet internally recalculates and verifies the MAC against its own cryptographic material. If correct, it updates its internal state to “activated”, and subsequently generates a dynamic, valid cryptogram in response to future NDEF READ commands, now behaving as a fully operational authenticated applet. Should the MAC check fail, the applet rejects the activation and remains inactive. This embodiment provides a streamlined, universally accessible activation process while ensuring the final transition to operational state is cryptographically secure.

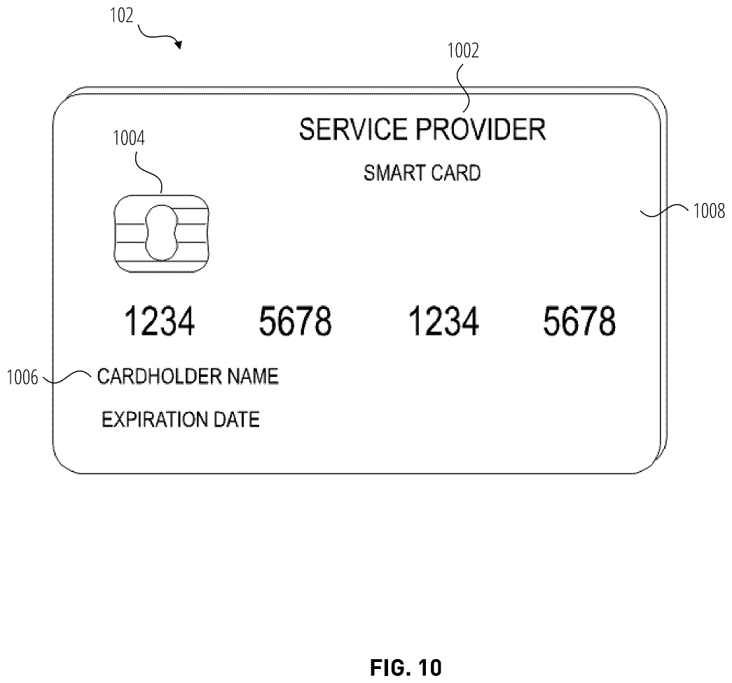

FIG. 10 illustrates an example configuration of a contactless card 102, which may include a contactless card, a payment card, such as a credit card, debit card, or gift card, issued by a service provider as displayed as service provider indicia 1002 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 1008, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

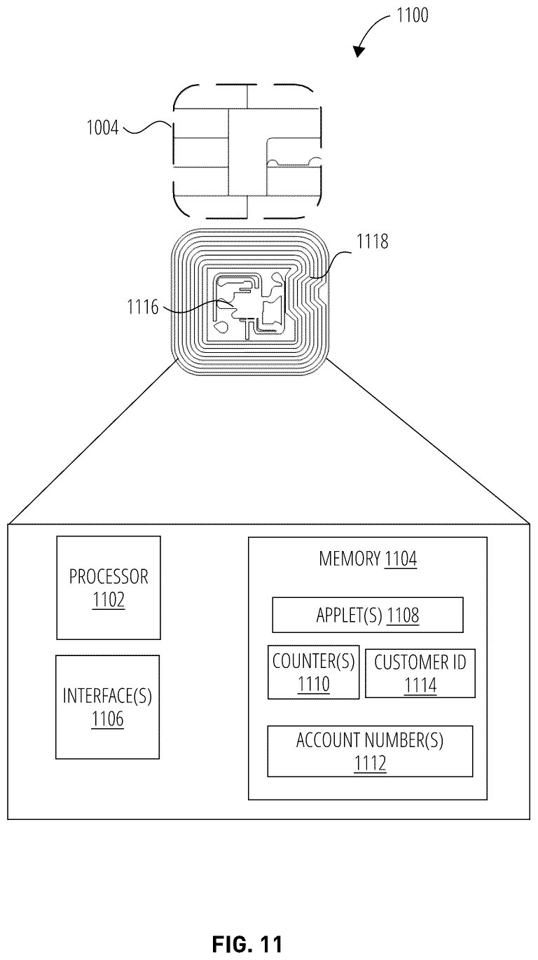

The contactless card 102 may also include identification information 1006 displayed on the front and/or back of the card, and a contact pad 1004. The contact pad 1004 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 11. These components may be located behind the contact pad 1004 or elsewhere on the substrate 1008, e.g. within a different layer of the substrate 1008, and may electrically and physically coupled with the contact pad 1004. The contactless card 102 may also include a magnetic strip or tape, which may be located on the back of the card (not shown in FIG. 10). The contactless card 102 may also include a Near-Field Communication (NFC) device coupled with an antenna capable of communicating via the NFC protocol. Embodiments are not limited in this manner.

As illustrated in FIG. 10, the contact pad 1004 of contactless card 102 may include processing circuitry 1116 for storing, processing, and communicating information, including a processor 1102, a memory 1104, and one or more interface(s) 1106. It is understood that the processing circuitry 1116 may contain additional components, including processors, memories, error and parity/CRC checkers, data encoders, anticollision algorithms, controllers, command decoders, security primitives and tamperproofing hardware, as necessary to perform the functions described herein.

The memory 1104 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 1104 may be encrypted memory utilizing an encryption algorithm executed by the processor 1102 to encrypted data.

The memory 1104 may be configured to store one or more applet(s) 1108, one or more counter(s) 1110, a customer identifier 1114, and the account number(s) 1112, which may be virtual account numbers. The one or more applet(s) 1108 may comprise one or more software applications configured to execute on one or more contactless cards, such as a Java® Card applet. However, it is understood that applet(s) 1108 are not limited to Java Card applets, and instead may be any software application operable on contactless cards or other devices having limited memory. The one or more counter(s) 1110 may comprise a numeric counter sufficient to store an integer. The customer identifier 1114 may comprise a unique alphanumeric identifier assigned to a user of the contactless card 102, and the identifier may distinguish the user of the contactless card from other contactless card users. In some examples, the customer identifier 1114 may identify both a customer and an account assigned to that customer and may further identify the contactless card 102 associated with the customer's account. As stated, the account number(s) 1112 may include thousands of one-time use virtual account numbers associated with the contactless card 102. An applet(s) 1108 of the contactless card 102 may be configured to manage the account number(s) 1112 (e.g., to select an account number(s) 1112, mark the selected account number(s) 1112 as used, and transmit the account number(s) 1112 to a mobile device or a computing device 104 for autofilling by an autofilling service.

In some embodiments, the memory 1104 can include (e.g., have stored therein) the data from the fields shown in FIG. 11 and/or FIG. 16. The processor 1102 can then use the data from the fields to generate the message 1600 as described above.

The processor 1102 and memory elements of the foregoing exemplary embodiments are described with reference to the contact pad 1004, but the present disclosure is not limited thereto. It is understood that these elements may be implemented outside of the contact pad 1004 or entirely separate from it, or as further elements in addition to processor 1102 and memory 1104 elements located within the contact pad 1004.

In some examples, the contactless card 102 may comprise one or more antenna(s) 1118. The one or more antenna(s) 1118 may be placed within the contactless card 102 and around the processing circuitry 1116 of the contact pad 1004. For example, the one or more antenna(s) 1118 may be integral with the processing circuitry 1116 and the one or more antenna(s) 1118 may be used with an external booster coil. As another example, the one or more antenna(s) 1118 may be external to the contact pad 1004 and the processing circuitry 1116.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 1118, processor 1102, and/or the memory 1104, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 1108 may be added to contactless cards to provide a one-time password (OTP) for multifactor authentication (MFA) in various mobile application-based use cases. Applet(s) 1108 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 1108 may be configured to encode the OTP as an NDEF type 4 well known type text tag. In some examples, NDEF messages may comprise one or more records. The applet(s) 1108 may be configured to add one or more static tag records in addition to the OTP record.

In some examples, the one or more applet(s) 1108 may be configured to emulate an RFID tag. The RFID tag may include one or more polymorphic tags. In some examples, each time the tag is read, different cryptographic data is presented that may indicate the authenticity of the contactless card. Based on the one or more applet(s) 1108, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 1110 may be configured to increment. In some examples, each time data from the contactless card 102 is read (e.g., by a mobile device), the counter(s) 1110 is transmitted to the server for validation and determines whether the counter(s) 1110 are equal (as part of the validation) to a counter of the server.

The one or more counter(s) 1110 may be configured to prevent a replay attack. For example, if a cryptogram has been obtained and replayed, that cryptogram is immediately rejected if the counter(s) 1110 has been read or used or otherwise passed over. If the counter(s) 1110 has not been used, it may be replayed. In some examples, the counter that is incremented on the card is different from the counter that is incremented for transactions. The contactless card 102 is unable to determine the application transaction counter(s) 1110 since there is no communication between applet(s) 1108 on the contactless card 102.

In some examples, the counter(s) 1110 may get out of sync. In some examples, to account for accidental reads that initiate transactions, such as reading at an angle, the counter(s) 1110 may increment but the application does not process the counter(s) 1110. In some examples, when the computing device 104 is woken up, NFC may be enabled and the computing device 104 may be configured to read available tags, but no action is taken responsive to the reads.

To keep the counter(s) 1110 in sync, an application, such as a background application, may be executed that would be configured to detect when the mobile computing device 104 wakes up and synchronize with the server of a banking system indicating that a read that occurred due to detection to then move the counter(s) 1110 forward. In other examples, Hashed One Time Password may be utilized such that a window of mis-synchronization may be accepted. For example, if within a threshold of 10, the counter(s) 1110 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 1110 increases in the appropriate sequence, then it possible to know that the user has done so.

The key diversification technique described herein with reference to the counter(s) 1110, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

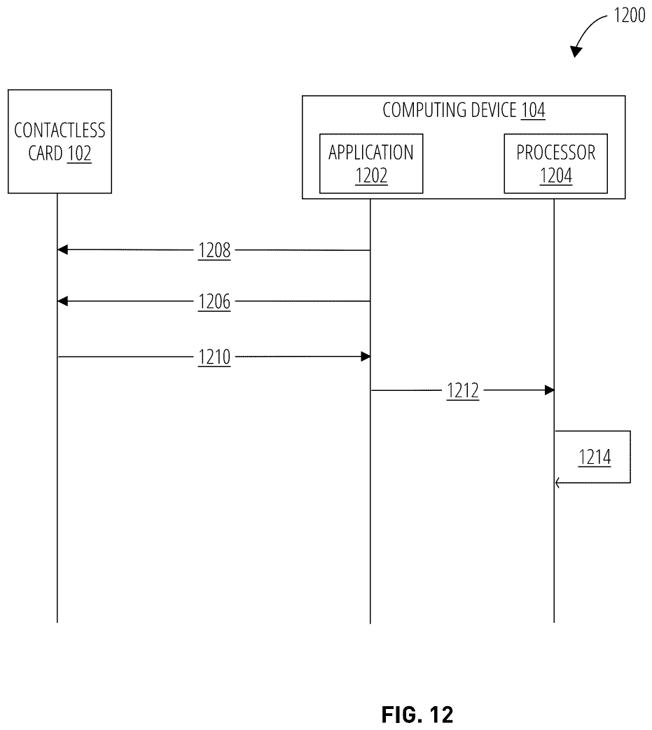

FIG. 12 is a timing diagram illustrating an example sequence for providing authenticated access according to one or more embodiments of the present disclosure. Sequence flow 1200 may include contactless card 102 and computing device 104, which may include an application 1202 and processor 1204. The steps described in this sequence flow 1200 provide one example in which encrypted data is passed from the contactless card 102 to the computing device 104. The encrypted data can be used to perform multi-factor authentication, as described above.

At line 1208, the application 1202 communicates with the contactless card 102 (e.g., after being brought near the contactless card 102). Communication between the application 1202 and the contactless card 102 may involve the contactless card 102 being sufficiently close to a card reader (not shown) of the computing device 104 to enable NFC data transfer between the application 1202 and the contactless card 102.

At line 1206, after communication has been established between computing device 104 and contactless card 102, contactless card 102 generates a message authentication code (MAC) cryptogram. In some examples, this may occur when the contactless card 102 is read by the application 1202. In particular, this may occur upon a read, such as an NFC read, of a near field data exchange (NDEF) tag, which may be created in accordance with the NFC Data Exchange Format. For example, a reader application, such as application 1202, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1202 may be configured to transmit a request to contactless card 102, the request comprising an instruction to generate a MAC cryptogram.

At line 1210, the contactless card 102 sends the MAC cryptogram to the application 1202. In some examples, the transmission of the MAC cryptogram occurs via NFC, however, the present disclosure is not limited thereto. In other examples, this communication may occur via Bluetooth, Wi-Fi, or other means of wireless data communication. At line 1212, the application 1202 communicates the MAC cryptogram to the processor 1204.

At line 1214, the processor 1204 verifies the MAC cryptogram pursuant to an instruction from the application 1202. For example, the MAC cryptogram may be verified, as explained below. In some examples, verifying the MAC cryptogram may be performed by a device other than computing device 104, such as a server of a banking system in data communication with the computing device 104. For example, processor 1204 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 13 illustrates an example of system 1300 in accordance with the embodiments discussed herein. The system 1300 includes additional devices and systems configured to enable contactless card issuers to tap-to-card services. Specifically, system 1300 enables any number of issuer systems to provide card services to their clients through a switching fabric, i.e., the switchboard system in a secure and safe manner. This system 1300 can be used to transmit the encrypted data from the contactless card 102 to the authentication server 112 for validation. In some embodiments, the authentication server 112 of FIG. 1 can be embodied by one of the nodes 1304 in FIG. 13.

In embodiments, the switchboard system includes one or more nodes 1304 configured to perform routing operations. Each switchboard node 1304 may include a session and nonce generator 1306, a message router 1308, an authentication 1310, an operation data 1312 store, and a metrics store 1314. Further, each of the nodes may be configured the same and share configurations, but each switchboard node 1304 may independently process and route messages and requests to the appropriate systems, such as the merchant systems and issuer systems. Each of the nodes 1304 is configured to act as a broker of trust between an issuer system, the merchant system 1322, and/or validation system 1324, for example. Each switchboard node 1304 is configured to route each message to the correct issuer system while maintaining data security. For example, a switchboard node 1304 may route a message between an issuer system and a merchant system while the node cannot access the private data in the message.

The switchboard system 1300 may be configured as a server system with a collection of hardware, software, and networking components that work together to provide client services. Hardware components may include one or more server computers, storage devices, and network adapters. The server computers are configured to run server applications, such as those executable on each of the nodes 1304. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 1304 may operate in a cloud-based computing environment, e.g., a collection of hardware, software, and networking components that enable the delivery of cloud computing services. The switchboard nodes 1304 and the computing services are delivered over the Internet and can be accessed from anywhere in the world with an Internet connection. In embodiments, client 1336 may access a switchboard node 1304 through DNS 1302 or Domain Name System (DNS). The DNS 1302 is a hierarchical and distributed naming system for computers, services, and other resources connected to the Internet or other networks. It associates various information with domain names assigned to each registered participant. In one example, the DNS 1302 may translate a name known to software executing on a client 1336 to route data to one or more of switchboard node 1304 of the switchboard system. In embodiments, the DNS 1302 may generate a number, such as an Internet Protocol (IP) address, an address record (A-record), or another Hostname (C-name record). FIG. 14 illustrates one example sequence 1400 for a client to identify and resolve an identifier for one of the nodes 1304 of the switchboard system. At a high level, the DNS 1302 translates known domain names to numerical Internet Protocol (IP) addresses needed for locating and identifying computer services and devices with the underlying network protocols. Clients use the global DNS system to select the best node to use, as discussed in sequence 1400.

In embodiments, a client 1336 communicates with the switchboard system to perform one or more of the partner services 1332, such as conducting a transaction with a merchant, validating the customer, or other tap-to functions. Once client 1336 identifies a switchboard node 1304 and resolves an address to communicate with switchboard node 1304, client 1336 may send one or more messages to switchboard node 1304 to authenticate and perform the operation. The switchboard node 1304 includes an authentication 1310 function that is configured to authenticate the client 1336. In embodiments, the client 1336 sends a message or authorization request to the switchboard node 1304 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

| Value | Name | Meaning |
|---|---|---|
| 6553 [symbol] | Client ID | Individual identifier of client |
| GReyx5BuEA [symbol] | Client Key | Randomly assigned key |

[symbol]

indicates data missing or illegible when filed

The switchboard node 1304 may authorize or authenticate the client 1336 or user, and the switchboard node 1304 may utilize the additional components, such as the session and nonce session and node generator 1306 and message router 1308, to perform the operations. Note the validation systems validation system 1324 never interact with the merchant systems 1322, nor vice versa. The nodes node 1304 brokers all communication.

In embodiments, the switchboard system may utilize a hyper ledger fabric 1320 to manage to synchronize the shared operation data 1312 and member management across the network. The hyperledger fabric 1320 is distributed ledger framework having a permissioned network model that only authorized participants can join the network and access the data that is stored on a ledger.

In embodiments, the hyperledger fabric 1320 may be generated by creating one or more sets of peers, an ordering service, and a channel. Once the network is created, system 1300 deploys chaincode to the network, or node 1304 is permitted to access the fabric. The chaincode is the code that runs on the blockchain and executes the network control 1326 and operation data 1312 logic code. Once the chaincode is deployed, each of the switchboard nodes 1304 is configured to invoke transactions on the blockchain to add data to the blockchain, e.g., the operational data. A switchboard node 1304 or another device can query the ledger to retrieve data. The ledger is a distributed database that stores all the data added to the blockchain.

All nodes 1304 keep an independently verifiable log of their actions that can be transmitted to a centralized aggregator to build a picture of overall network usage. System 1300 can manage network operation data and management at a central level and have a centralized view of network use, aggregated and abstracted to the appropriate level.

FIG. 14 illustrates an example sequence 1400 for a client to utilize DNS to resolve and communicate with one or more nodes of a switchboard system 1300 in FIG. 13. The illustrated sequence 1400 includes a client 1336, a DNS 1302, and a switchboard node 1304. At 1402, the sequence 1402 includes the client 1336 sending a request to a default DNS server for a text record switchboard. {domain}. {tld}. The text record may be preconfigured in a client app and/or client SDK. At 1404, the DNS 1302 returns one or more records. A DNS record structure may include the following:
Root Record:
   Name: switchboard. {domain}. {tld}
   Type: TXT
   Resolution:
      {nodename_1}. {operator_a}. {region_i}.switchboard. {domain}. {tld},
      {nodename_2}. {operator_a}. {region_i}.switchboard. {domain}. {tld},
      {nodename_1}. {operator_b}. {region_ii}.switchboard. {domain}. {tld},
      {nodename_2}. {operator_b}. {region_ii}.switchboard. {domain}. {tld},
      * etc.
   Used For determining where there are active nodes
Node Record:
   Name: {nodename}. {operator}. {region}.switchboard. {domain}. {tld}
   Type: A/AAAA or CNAME
   Resolution: Actual node hostname or IP
   Used For: communicating with a node 1304

In embodiments, the client 1336 may determine the current timezone at 1406. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1408, the client 1336 is configured to map the timezone to a region or short-version identifier of the region. One example includes America/New_York->na-e. The region may be based on DNS names, for example. Table 2 illustrates a few examples of timezone mappings to regions:

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e <-> na-w and sa <-> na-w and sa <-> na-e. This representation is useful for node selection.

At 1410, the client 1336 may identify or select a DNS record option returned at 1404 that is in the region. If there are multiple matches, the client 1336 may select one at random. If there's no node available in a region, the client 1336 may determine and use a data graph of neighboring regions to select a node in the closest region where a node is available at 1412. For example, sa has no node but is connected to na-e where there is a node and so na-e is selected. In some embodiments,

At 1414, the client may resolve a selected node's hostname. In embodiments, the client 1336 may automatically resolve the hostname using the client's HTTP request default resolver. At 1416, the DNS 1302 may return a result. And at 1418, the client 1336 may communicate with a switchboard node 1304 and begin the process to interact with the switchboard.

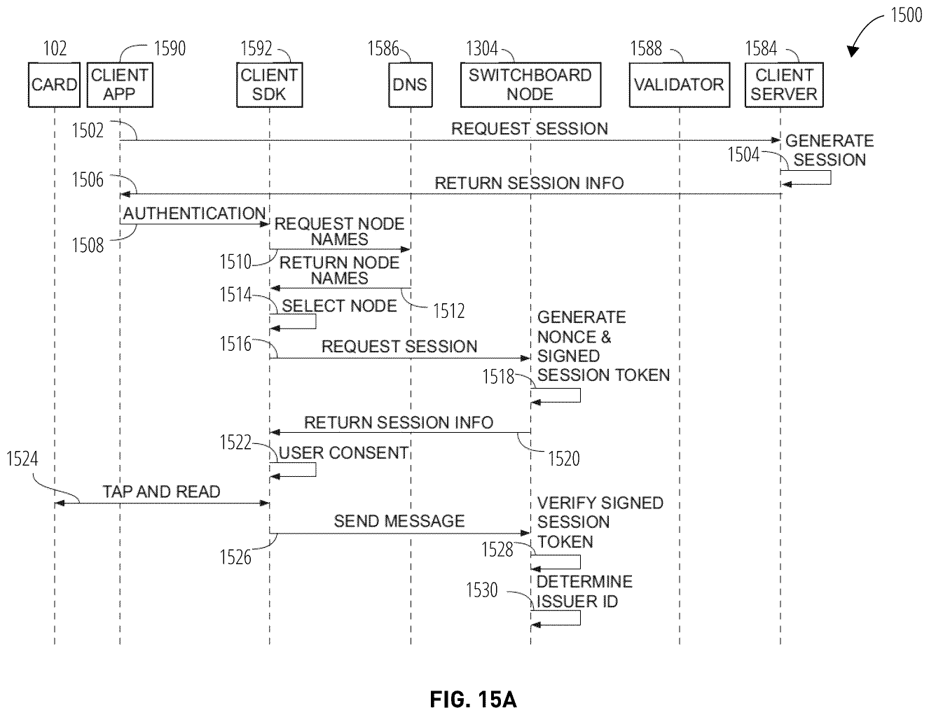

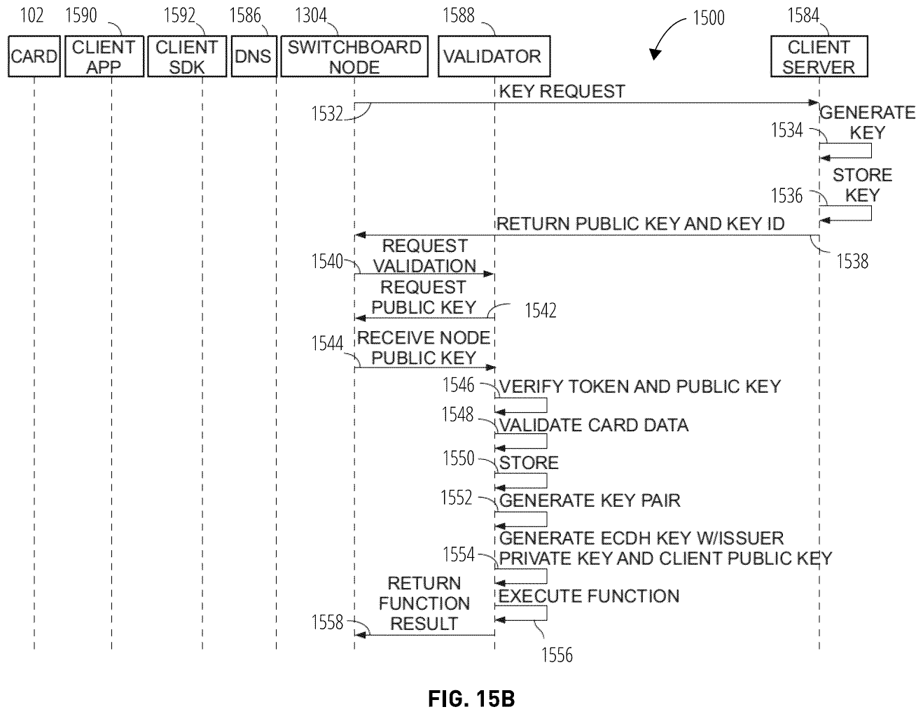

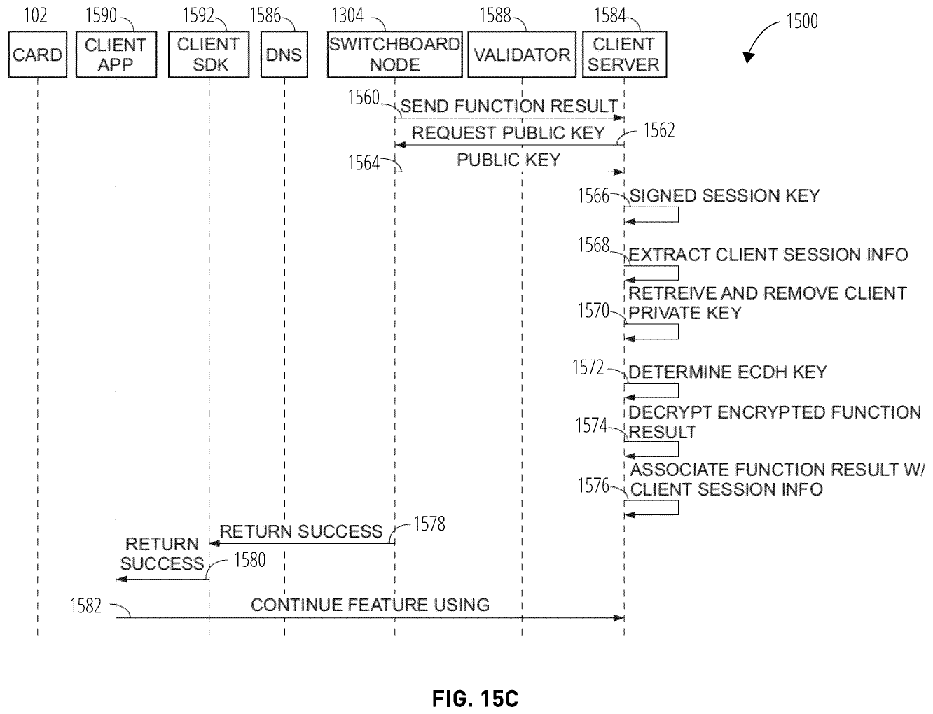

FIG. 15A-FIG. 15C illustrate an example sequence 1500 to perform operations between a contactless card 102 and services provided by a card issuer and/or merchant. The illustrated sequence 1500 includes actions and communications performed by a contactless card 102, a client 1336 including a client app 1590 and a client SDK 1592, a DNS 1586, a switchboard system including one or more nodes 1304, a partner services 1332 including a merchant and/or validator 1588, and control services 1334 including a client server 1584 or system. In embodiments, the client app 1590 may be any application configured to execute on a client 1336, such as a banking app, a merchant app, a social media app, a travel app, a gaming app, a productivity app, an entertainment app, and so forth. In embodiments, the client app 1590 includes a web browser to provide websites and pages. The client app 1590 may include and/or utilize the client SDK 1592, which may be a set of instructions that enable the client app 1590 to communicate with other components of the switchboard system.

In embodiments, as shown in FIG. 15A, at 1502 the client 1336 including the client app may send a request and establish a session with a client server 1584 such that a result may be associated with the correct client device or user. The request establishes a relationship between the client device and client server, which may be an issuer server. At 1504, the client server 1584 generates a session and CLIENT SESSION INFORMATION. At 1506, the client server 1584 returns the session information, e.g., the CLIENT SESSION INFORMATION. In embodiments, the CLIENT SESSION INFORMATION may be the Client implementation-specific user session identification information.

At 1508, the client 1336 may initiate a contactless card authentication process with the client 1336. For example, the client 1336 may call a function and/or pass information to the client 1336 to initiate authentication via a contactless card 102. At 1510-1514, the client 1336 may utilize DNS to identify a node and establish communication with the node. Specifically, at 1510, the client 1336 including the client SDK 1592 may send a request for switchboard hostnames, and at 1512 the DNS 1586 may return information including one or more hostnames. At 1514, the client 1336 may determine a switchboard node to communicate. FIG. 14 illustrates an example of a more detailed sequence of the process to establish communication with a switchboard node 1304.

At 1516, the client 1336 may send a request for a session to the switchboard system 1300. In embodiments, the request for a session may be for a function request in the format <FUNCTION REQUEST>. In embodiments, the FUNCTION REQUEST may be the data/function that the client 1336 would like to request once a contactless card 102 has been validated. The function could be for any service discussed herein, e.g., authenticate the user, perform a transaction, request autofill data, etc. At 1518, switchboard system 1300 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 1300 private key. The switchboard system 1300 may include a NODE PUBLIC/PRIVATE KEY, which is a keypair used to sign and validate JWTs.

At 1520, the switchboard system 1300 may return session information to the client 1336. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1522, the client SDK 1592 may determine and/or receive user consent to the terms of service. In one example, the client SDK 1592 captures and records the user consent to <FUNCTION TOS> on <CONSENT DATE>with <TOS VERSION>. The CONSENT DATE may be the timestamp for the user's consent to the TOS.

At 1524, the client 1336 exchanges one or more messages with a contactless card. In one example, the exchange may be based on the contactless card being tapped to a client device. In embodiments, the client SDK 1592 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record Type | 01 |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date creation | 16 bytes of ASCII HEX encoded 8 bytes binary |
| | Time | data - represents 64 bit unix timestamp |
| 27 . . . 36 | Update MAC | MAC to protect control indicators - 16 bytes of |
| | | ASCII HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 16, message 1600.

At 1524, the contactless card may generate and provide a message to the client's device including the client SDK 1592. The data in the message may be utilized by the system discussed herein to perform the function requested. One example of the message is illustrated and discussed in FIG. 16, message 1600.

At 1526, the client including the client SDK 1592 may send a message and information to the switchboard system 1300. The message may be the message received from the contactless card 102, e.g., message 1600. In addition, the client SDK 1592 may send the consent date, the TOS version, and the signed session token to the switchboard system 1300. The switchboard system 1300 may utilize the information to ensure the session is valid. At 1528, the switchboard system 1300 verifies the signed session token is valid, e.g., is the previously provided signed session token and includes the nonce previously generated and is in the message.

In some embodiments, the switchboard system 1300 is configured to determine which issuer system or client-server it should route the message to for processing. At 1530, the switchboard system 1300 may determine the Issuer ID by extracting it from the message received from the contactless card 102 via the client SDK 1592. As mentioned, the Issuer ID identifies the issuer of the contactless card 102.

FIG. 15B continues the sequence 1500 from FIG. 15A. In embodiments, the switchboard system 1300 is configured to generate and communicate secure communications with the issuer system, e.g., the client server 1584 and the validator 1588. At 1532, the switchboard system 1300 sends a request for a key to the client server 1584. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1534, the client server 1584 generates a portion of the key. In some instances, the client server 1584 may generate half of the ECDH key for encryption/decryption of PII. Specifically, the client server 1584 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1536, the client-server 1584 stores the generated portion of the key in storage. Specifically, the client server 1584 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1584 may return the public key portion to the switchboard system 1300 with the KEY ID at 1538. The switchboard system 1300 may store the public key portion with the KEY ID for later use, e.g., generation of the ECDH key. At 1540, the switchboard system 1300 may request a validation to be performed by the validator 1588. In one example, the switchboard system 1300 may send a request validation as Request validation <MESSAGE>, <SIGNED SESSION TOKEN>, <CLIENT EC PUBLIC KEY>, <CONSENT DATE>, and the <TOS VERSION>. The validator 1588 may make an out-of-band request back to the switchboard system 1300 for the public key to verify the session at 1542. At 1544, the switchboard system 1300 may provide the node's public key, i.e., <NODE PUBLIC KEY>. Further at 1546, the validator 1588 may utilize the node's public key to verify the secure session token.

In embodiments, the validator 1588 may validate the message at 1548. In embodiments, the validator 1588 may perform a number of validations including ensuring the nonce in the message is correct along with additional information, such as the card's unique identifier (pUID), and the counter value (pATC).

At 1550, the validator 1588 may store information associated with the session. For example, validator 1588 may store the <CONSENT DATE> with the <TOS VERSION> and the <pUID>. The validator 1588 may also generate another portion of the key, e.g., the ECDH key. For example, the 1588 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1554, the validator 1588 may generate the complete ECDH key. For example, the validator 1588 generates the <ECDH KEY> from <ISSUER EC PRIVATE KEY> and <CLIENT EC PUBLIC KEY>. The ECDH KEY is the final key generated using ECDH key negotiation.

The validator 1588 may utilize the ECDH KEY to encrypt data for the function. For example, if the validator 1588 validates the message in some instances, the validator 1588 may execute a function request to create a function result and encrypt the result with the ECDH KEY at 1556. For example, the validator 1588 may Execute <FUNCTION REQUEST> to create <FUNCTION RESULT> and encrypt it with the <ECDH KEY>. The function result may be any result based on the requested function, e.g., verification of the card.

At 1558, the validator 1588 may return the function result to the switchboard system 1300. In some instances, the function result is returned encrypted. For example, the validator 1588 may return the <ENCRYPTED FUNCTION RESULT> and the <ISSUER EC PUBLIC KEY>.

FIG. 15C continues the sequence 1500 from FIG. 15B. In embodiments, at 1560 the switchboard system 1300 sends the function result to the client server 1584 to process the result. In one example, the switchboard system 1300 may send the <ENCRYPTED FUNCTION RESULT>, <KEY ID>, <ISSUER EC PUBLIC KEY>, and <SIGNED SESSION TOKEN>. At 1562 and 1564, the client server 1584 may make a request for and receive the public key from the switchboard system 1300. In some instances, the exchange may be performed via out-of-band communication channels. The public key for the node may be <NODE PUBLIC KEY>. The public key may be used to verify the sender of the function result, etc. At 1566, the client server 1584 may verify the signed session key with the node's public key <NODE PUBLIC KEY> to verify the sender of the information. At 1568, the client server 1584 may extract client information from the signed session token. For example, the client server 1584 may Extract <CLIENT SESSION INFO> from <SIGNED SESSION TOKEN>, i.e., extracting the client implementation-specific user session identification information.

Further, at 1570, the client server 1584 may retrieve the client's private key with the KEY ID. Specifically, the client server 1584 may get and remove the <CLIENT PRIVATE KEY> from cache using the <KEY ID>. At 1572, the client server 1584 may generate or compute the ECDH key. For example, the client server 1584 may compute the <ECDH KEY> with the <CLIENT PRIVATE KEY>+<ISSUER EC PUBLIC KEY>. The client server 1584 may decrypt the function result with the computed key at 1574. Specifically, the client server 1584 may decrypt the <ENCRYPTED FUNCTION RESULT> with the <ECDH KEY> to determine the <FUNCTION RESULT>. At 1576, the client server 1584 associates the function result with the session.

In embodiments, the switchboard system 1308 may return whether the function result was successfully completed or not at 1578 to the client SDK 1592. Further at 1580, the client SDK 1592 may notify the client app 1590 of the result. At 1582, the client app 1590 may utilize the feature. For example, the 1582 may communicate with the client server 1584 to continue the feature using the <CLIENT SESSION INFO> to fetch the redacted <FUNCTION RESULT>.

FIG. 16 illustrates an example of a message 1600 that may be communicated by a contactless card to perform the functions described herein, such as those discussed in FIG. 15A through FIG. 15C. The message 1600 may include the encrypted data that is sent from the contactless card 102 to the computing device 104 for authentication, as described above. One or more of the fields in message 1600 may also be utilized to route the message 1600 through the switchboard system and perform authentication/validation techniques.

In embodiments, the message 1600 includes an applet version 1602 field, an issuer discretionary indicator 1604 field, an Issuer Identifier 1606 field, a pKey ID 1608 field, a pUID 1610 field, a pATC 1612 field, a nonce 1614 field, and an encrypted cryptogram 1616.

In embodiments, the fields may be in plain text or encrypted. For example, the applet version 1602 field may include an applet version in plain text. The applet version indicates which applet version is installed on a contactless card and may be used by the other systems to determine how to process the message 1600 when communicated. For example, different Applet versions require different validation logic, e.g., an older message may be routed through the issuer system to perform various operations for validation, while a newer message may be routed through the switchboard system to perform the various operations, including validation.

In embodiments, the message 1600 includes an issuer discretionary indicator 1604 field that may include issuer data and set at the time of personalization. In addition, the message 1600 includes an Issuer Identifier 1606 field that may include a unique ID assigned to the entity issuing the card, e.g., the issuer. For example, when joining the system, each issuer may be assigned a unique identifier during an onboarding operation. The Issuer ID can be used by the switchboard system 1308 to route a message and its contents to the appropriate services that are associated with that particular issuer.

In embodiments, the message 1600 includes a pKey ID 1608 field. In some instances, the pKey ID 1608 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1600 may include a pUID 1610 field, including a card unique identifier assigned to the contactless card at personalization time. The pUID 1610 field data may be a combination of alphanumeric characters used to identify each card and associated with a user uniquely.

In embodiments, the message 1600 includes a pATC 1612 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1600 is created, a new session key is derived and utilized to generate one or more portions of the message 1600. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1600 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2] ∥ ATC[3] ∥ ‘F0’ ∥ ‘00’ ∥ [ATC[0] ∥ [ATC[1] ∥ [ATC[2] ∥ [ATC[3]] with an application key. Further, the contactless card 102 computes SKR by encrypting [ATC[2] ∥ ATC[3] ∥ ‘0F’ ∥ ‘00’ ∥ [ATC[0] ∥ [ATC[1] ∥ [ATC[2] ∥ [ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2] ∥ ATC[3] ∥ ‘F0’ ∥ ‘00’ ∥ ‘00’ ∥ ‘00’ ∥ ‘00’ ∥ ‘00’] with a Data Encryption Key (DEK) or UDK. Further, the contactless card 102 computes SKR by encrypting [ATC[2] ∥ ATC[3] ∥ ‘0F’ ∥ ‘00’ ∥ ‘00 ∥ ‘00’ ∥ ‘00’ ∥ ‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1 ∥ T2 ∥ T3 ∥ T4. The contactless card 102 computes B=DES (ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES (ASKL) [B], where DES is an encryption algorithm. The contactless card 102 computes B=[B XOR T3], and the contactless card 102 computes B=DES (ASKL) [B]. The contactless card 102 computes B=[B XOR T4], and the contactless card 102 computes B=DES (ASKL) [B]. The contactless card 102 computes B=DES-1 (ASKR) [B], where DES-1 is the reciprocal DES operation, and ASKR is a portion of the ASK, e.g., the right half. The contactless card 102 computes the cryptogram C=DES (ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E]1 ∥ [E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes) ∥ Update Date Time (8 bytes) ∥ ‘80’ ∥ ‘00 00 00 00 00’]. For the calculations, the data may be divided into two separate portions. Specifically, the data U is broken into two blocks of 8 bytes of data, where U=U₁∥ U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

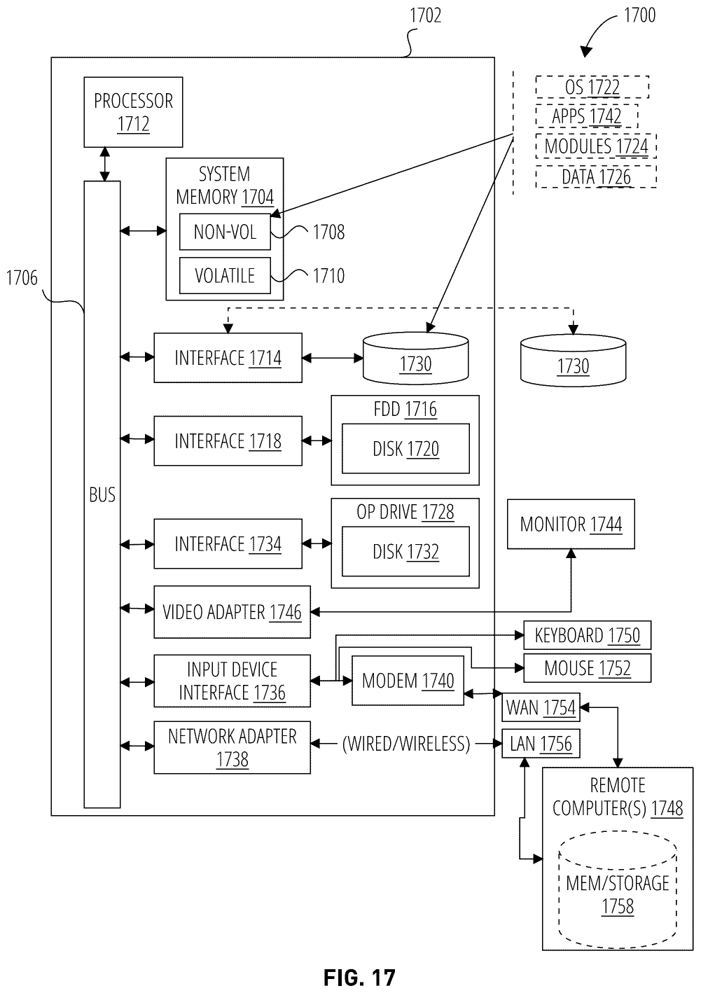

FIG. 17 illustrates an embodiment of an exemplary computer architecture 1700 suitable for implementing various embodiments as previously described. In one embodiment, the computer architecture 1700 may include or be implemented as part of one or more systems or devices discussed herein. For example, the computer architecture 1700 includes components that can implement one or more of the computing device 104, web server 108, bank server 110, authentication server 112, or centralized digital wallet server 114 described above.

As used in this application, the terms “system” and “component” are intended to refer to a computer-related entity, either hardware, a combination of hardware and software, software, or software in execution, examples of which are provided by the exemplary computer architecture 1700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bidirectional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1700 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 1500.

As shown in FIG. 17, the computer architecture 1700 includes a processor 1712, a system memory 1704 and a system bus 1706. The processor 1712 can be any of various commercially available processors or processor circuits.

The system bus 1706 provides an interface for system components including, but not limited to, the system memory 1704 to the processor 1712. The system bus 1706 can be any of several types of bus structure that may further interconnect to a memory bus (with or without a memory controller), a peripheral bus, and a local bus using any of a variety of commercially available bus architectures. Interface adapters may connect to the system bus 1706 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 17, the system memory 1704 can include non-volatile 1708 and/or volatile 1710. A basic input/output system (BIOS) can be stored in the non-volatile 1708.

The computer 1702 may include various types of computer-readable storage media in the form of one or more lower speed memory units, including an internal (or external) hard disk drive 1730, a magnetic disk drive 1716 to read from or write to a removable magnetic disk 1720, and an optical disk drive 1728 to read from or write to a removable optical disk 1732 (e.g., a CD-ROM or DVD). The hard disk drive 1730, magnetic disk drive 1716 and optical disk drive 1728 can be connected to system bus 1706 the by an HDD interface 1714, and FDD interface 1318 and an optical disk drive interface 1534, respectively. The HDD interface 1714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1708, and volatile 1710, including an operating system 1722, one or more applications 1742, other program modules 1724, and program data 1726. In one embodiment, the one or more applications 1742, other program modules 1724, and program data 1726 can include, for example, the various applications and/or components of the systems discussed herein.

A user can enter commands and information into the computer 1702 through one or more wire/wireless input devices, for example, a keyboard 1750 and a pointing device, such as a mouse 1752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1712 through an input device interface 1736 that is coupled to the system bus 1706 but can be connected by other interfaces such as a parallel port, IEEE 1394 serial port, a game port, a USB port, an IR interface, and so forth.

A monitor 1744 or other type of display device is also connected to the system bus 1706 via an interface, such as a video adapter 1746. The monitor 1744 may be internal or external to the computer 1702. In addition to the monitor 1744, a computer typically includes other peripheral output devices, such as speakers, printers, and so forth.

The computer 1702 may operate in a networked environment using logical connections via wire and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all the elements described relative to the computer 1702, although, for purposes of brevity, only a memory and/or storage device 1758 is illustrated. The logical connections depicted include wire/wireless connectivity to a local area network 1756 (LAN) and/or larger networks, for example, a wide area network 1754 (WAN). Such LAN and WAN networking environments are commonplace in offices and companies, and facilitate enterprise-wide computer networks, such as intranets, all of which may connect to a global communications network, for example, the Internet.

When used in a local area network 1756 networking environment, the computer 1702 is connected to the local area network 1756 through a wire and/or wireless communication network interface or network adapter 1738. The network adapter 1738 can facilitate wire and/or wireless communications to the local area network 1756, which may also include a wireless access point disposed thereon for communicating with the wireless functionality of the network adapter 1738.

When used in a wide area network 1754 networking environment, the computer 1702 can include a modem 1740, or is connected to a communications server on the wide area network 1754 or has other means for establishing communications over the wide area network 1754, such as by way of the Internet. The modem 1740, which can be internal or external and a wire and/or wireless device, connects to the system bus 1706 via the input device interface 1736. In a networked environment, program modules depicted relative to the computer 1702, or portions thereof, can be stored in the remote memory and/or storage device 1758. It will be appreciated that the network connections shown are exemplary and other means of establishing a communications link between the computers can be used.

The computer 1702 is operable to communicate with wire and wireless devices or entities using the IEEE 1502 family of standards, such as wireless devices operatively disposed in wireless communication (e.g., IEEE 1502.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

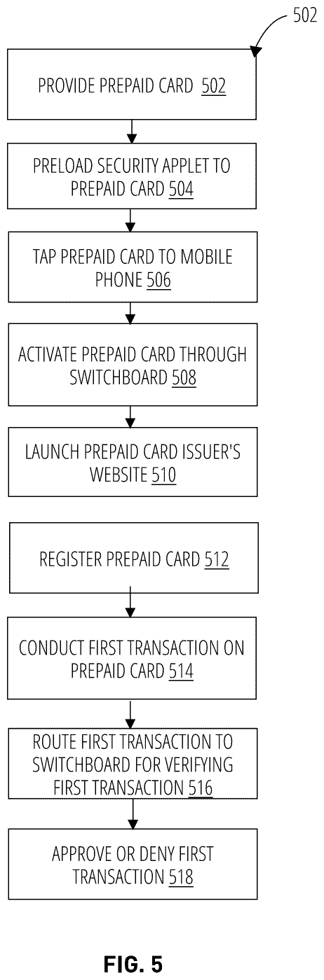

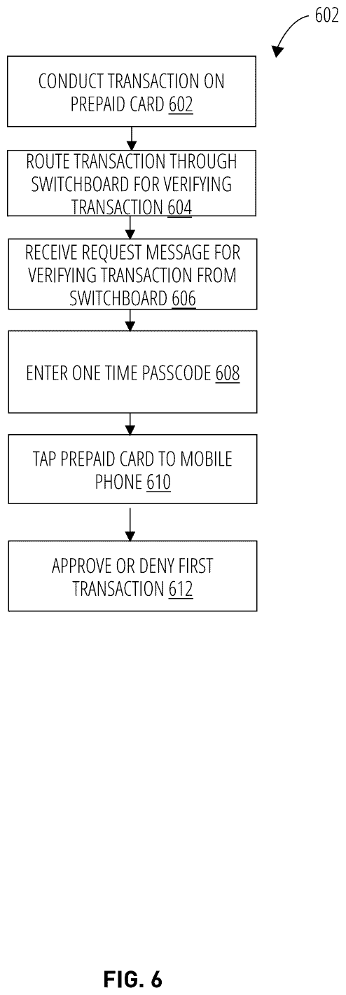

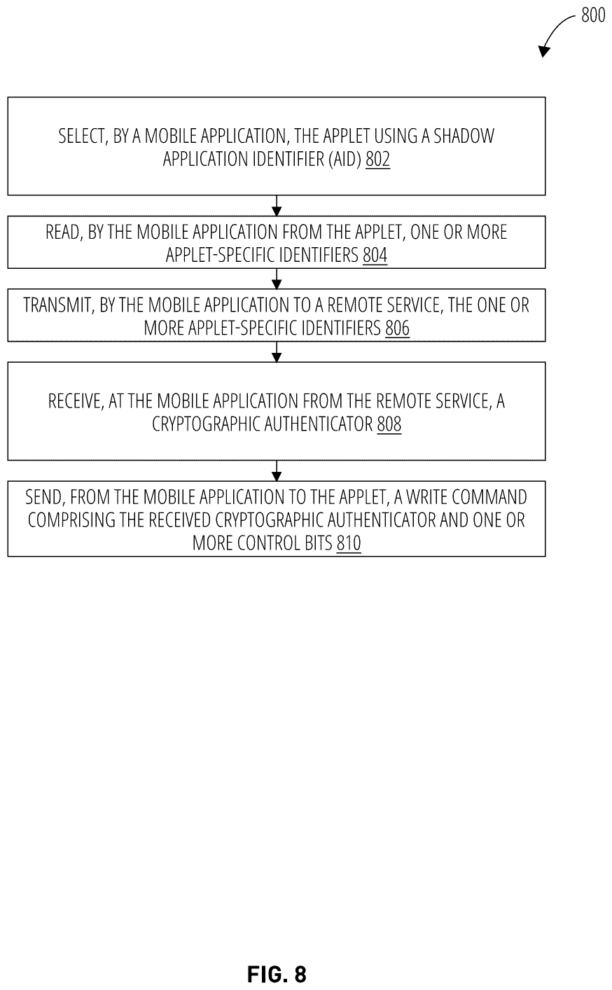

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, the term “merchant” is not limited to a particular merchant or type of merchant. Rather, the term includes any type of merchant, vendor, or other entity involving in activities where products or services are sold or otherwise provided.

As used herein, the term “bank” is not limited to a financial institution or other type of entity. Rather, the term includes any type of financial institution, business or industrial organization, or other entity involved in the handling or processing of transactions.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A computer-implemented method for activating an applet, the method comprising:
selecting, by a mobile application, the applet using a shadow application identifier (AID), wherein in the initial inactive state the applet is configured to respond exclusively to the shadow AID;
reading, by the mobile application from the applet, one or more applet-specific identifiers;
sending, by the mobile application to a remote service, the one or more applet-specific identifiers;
receiving, at the mobile application from the remote service, a cryptographic authenticator, wherein the cryptographic authenticator is generated by the remote service based at least in part on the one or more applet-specific identifiers;
sending, from the mobile application to the applet, a write command comprising the received cryptographic authenticator and one or more control bits; and
transitioning, by the applet, from the initial inactive state to the subsequent active state in response to a successful validation of the cryptographic authenticator, wherein said transitioning comprises enabling the applet to respond to the standard NDEF AID and disabling the applet from responding to the proprietary AID.

2. The computer-implemented method of claim 1, wherein sending the one or more applet-specific identifiers to the remote service is through a switchboard system configured to route the applet-specific identifiers to the remote service based on the Issuer ID.

3. The computer-implemented method of claim 1, wherein the one or more applet-specific identifiers comprise an Issuer Identifier (ID), a Key ID, and a Platform Unique Identifier (PUID).

4. The computer-implemented method of claim 1, wherein the cryptographic authenticator is a Control Message Authentication Code (MAC).

5. The computer-implemented method of claim 4, wherein the write command comprises the received Control MAC and one or more control bits configured to instruct the applet to transition to the active state.

6. A method for activating a applet, the method comprising:
performing, by a mobile application, a first read operation on the applet;
receiving, by the mobile application from the applet, a first message comprising one or more identifiers and a cryptogram field populated with a predetermined fixed value indicating an inactive state;
detecting, by the mobile application, said predetermined fixed value in the cryptogram field;
sending, from the mobile device to a remote service, the one or more identifiers;
receiving, at the mobile application from the remote service, a cryptographic authenticator; and
performing, by the mobile application, a write operation to transmit the cryptographic authenticator to the applet, causing the applet to validate the cryptographic authenticator and transition from the inactive state to an active state, wherein in the active state.

7. The method of claim 6, comprising perform a subsequent second read operation on the applet causes the applet to return a second message comprising a dynamically computed cryptogram.

8. The method of claim 6, wherein the one or more identifiers comprise an issuer identifier (Issuer ID), a key identifier (Key IDID), and a platform unique identifier (PUID).

9. The method of claim 6, wherein the mobile application is a web application that utilizes WebNFC to perform the first read operation and the write operation.

10. The method of claim 6, wherein sending the one or more identifiers further comprises routing the identifiers to a remote service based on the Issuer ID.

11. The method of claim 6, wherein the cryptographic authenticator is a Control MAC and causing the applet to validate the Control MAC comprises the applet internally recalculating an expected MAC and comparing it to the transmitted Control MAC.

12. A method for controlling fraud on a prepaid card, the method comprising:
providing the prepaid card with a preloaded applet, wherein the prepaid card is initially in an inactivated state;
receiving, from a merchant system, a first transaction request associated with the prepaid card, the first transaction request comprising a permanent account number (PAN) of the prepaid card;
in response to the first transaction request, determining that the prepaid card is in the inactivated state and requires a physical tap for activation;
subsequent to said determining, receiving, from a user's mobile device, tap data generated by a physical tap of the prepaid card against the mobile device, the tap data comprising a platform unique identifier (pUID) distinct from the PAN;
correlating the received pUID with the PAN associated with the first transaction request to identify the prepaid card;
activating the prepaid card based on the successful correlation; and
initiating a registration process on the user's mobile device, wherein the registration process associates user contact information with the now-activated prepaid card to enable subsequent transaction verification.

13. The method of claim 12, wherein initiating the registration process comprises causing the applet to launch a website of a card issuer on the user's mobile device.

14. The method of claim 12, wherein the user contact information comprises at least one of a phone number or an email address.

15. The method of claim 14, further comprising utilizing the associated user contact information to send a challenge, via a 3D Secure protocol, for verifying a subsequent transaction on the prepaid card.

16. The method of claim 12, further comprising: displaying the first transaction request as a pending transaction to a user during the registration process; and
receiving, from the user, an approval or denial of the pending transaction.

17. The method of claim 16, further comprising sending an alert to the user in response to the user denying the pending transaction, the alert indicating that a fraudulent transaction was attempted.

18. A contactless card, comprising:
a processor; and
a memory storing a secure applet, the secure applet having an initial inactive state,
wherein, in the initial inactive state, the secure applet is configured to be non-responsive to a selection request comprising a standard NFC Data Exchange Format (NDEF) Application Identifier (AID); and respond exclusively to a selection request comprising a secret, non-standard Shadow AID known only to a trusted activation application, and
wherein the secure applet is configured to transition from the initial inactive state to a subsequent active state only upon successful validation of a cryptographic authenticator received from an application, the transitioning comprising enabling the secure applet to respond to the standard NDEF AID and permanently disabling the secure applet from responding to the proprietary Shadow AID.

19. The contactless card of claim 18, wherein the cryptographic authenticator is a one-time Control Message Authentication Code (MAC).

20. The contactless card of claim 19, wherein the Control MAC is generated by a remote service based on one or more identifiers read from the secure applet via the proprietary Shadow AID.

21. The contactless card of claim 20, wherein the one or more identifiers comprise an Issuer ID, a Key ID, and a Platform Unique Identifier (PUID).

22. The contactless card of claim 18, wherein, in the initial inactive state, the only permitted operations on the secure applet are read and write access to an internal NDEF file via the secret Shadow AID.

23. The contactless card of claim 18, wherein the trusted activation application is a native mobile application installed on a computing device.

24. The contactless card of claim 18, wherein the secure applet internally recalculates a MAC using a secret key stored in the memory and compares the recalculated MAC to the received cryptographic authenticator to perform said validation.

25. The contactless card of claim 18, wherein the secure applet remains in the initial inactive state if the validation of the cryptographic authenticator fails.

26. The contactless card of claim 18, wherein the secure applet, once in the subsequent active state, is configured to support secure contactless communication for financial transactions.

27. A contactless card, comprising: a processor; and a memory storing an applet and instructions that, when executed by the processor, configure the contactless card to:
in response to a first read operation from a mobile device, transmit a first message comprising one or more identifiers and a cryptogram field populated with a predetermined fixed value indicating an initial inactive state of the applet;
receive, from the mobile device, a write operation comprising a cryptographic authenticator, wherein the cryptographic authenticator is generated by a remote service based on the one or more identifiers;
validate the cryptographic authenticator;
in response to a successful validation, transition the applet from the initial inactive state to a subsequent active state, wherein in the subsequent active state, a second read operation on the applet causes the applet to return a second message comprising a dynamically computed cryptogram.
